(19) United States
(12) Patent Application Publication
(10) Pub. No.: US 2010/0066269 A1
(43) Pub. Date: Mar. 18, 2010

(54) LIGHTING DEVICE

(75) Inventors: Gerardus Marinus Josephus Franciscus Luijks, Eindhoven (NL); Wouter Edgard Koen Broeckx, Eindhoven (NL); Mikhail Sorokin, Eindhoven (NL); Joseph Leonardus Gregorius Suijker, Eindhoven (NL); Denis Joseph Carel Van Oers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/517,566

(22) PCT Filed: Dec. 7, 2007
(86) PCT No.: PCT/IB2007/054973

§ 371 Date: Jun. 4, 2009

(30) Foreign Application Priority Data
Dec. 11, 2006 (EP) 06125792.9

(51) Int. Cl. H05B 37/02

(52) U.S. Cl. 315/294

(57) ABSTRACT

The invention provides a lighting device which is color-variable without a substantial deviation from the black body locus of the light generated by the lighting device. The lighting device is also dimmable without a substantial shift of the color point of the light generated by the lighting device. The lighting device is based on at least two CDM lamps.

### FIELD OF THE INVENTION

The present invention relates to a lighting device comprising a first and a second light source, the first and the second light source comprising a first and a second ceramic discharge vessel, respectively, the first light source being arranged to generate a first radiation having a first color temperature and the second light source being arranged to generate a second radiation having a second color temperature, the device thereby generating light with a third color temperature.

### BACKGROUND OF THE INVENTION

Lighting devices comprising two light sources of different color temperatures are known in the art. US2005/0225986, in the field of fluorescent lamps, describes a specific luminaire comprising a concave reflector and at least two lamps (low-pressure mercury vapor discharge lamps).

Lighting devices comprising two or more light sources are also known in the field of high-intensity discharge lamps (HID lamps). KR2002093743, for instance, describes a high-intensity discharge lamp in which two or three arc tubes are disposed in a single outer shell, thereby allowing an illuminance dimming operation. Each arc tube has a different color temperature. The arc tubes are arranged in a linear or triangular shape within the outer shell. JP10312897 describes a lighting system capable of continuous dimming over a wide input range by means of a so-called dimmable metal halide lamp without changing its light color. Light-emitting tubes are made of a light-transmitting material and are disposed in an outer tube made of quartz or glass. A closed space between the light-emitting tubes and the outer tube is vacuum or filled with low-pressure rare gas, outside air and the like, and the light-emitting tubes are closely insulated in temperature so as to limit the cooling of the light-emitting tubes. The light emitting tubes are connected to lighting circuits via external lead wires connected to a base.

High-intensity discharge metal halide lamps per se (i.e. not included in a lighting device comprising two or more light sources) are described, for example, in EP0215524 and WO2006/046175. Such lamps operate under high pressure and comprise ionizable gas fillings of, for example, NaI (sodium iodide), TlI (thallium iodide), CaI₂ (calcium iodide), and/or REIₙ. REIₙ refers to rare earth iodides. An important class of metal halide lamps are ceramic discharge metal halide lamps (CDM-lamps). The ionizable fillings (comprising rare earth salts) which are added to the discharge vessel of such lamps are added in amounts that lead to a saturated vapor when the discharge lamp is operated, thereby leaving part of the filling in a condensed phase. A possible reason for adding the filling in an amount that will lead to a saturated vapor during use of the lamp may be the fact that during use salts may react with the discharge vessel wall and/or other elements within the discharge vessel, which leads to a reduction of the amount of filling. Hence, when aiming at a discharge lamp with a constant output, providing a saturated gas filling seems a prerequisite.

### SUMMARY OF THE INVENTION

A well-known problem with dimming of ceramic discharge lamps is the fact that the color point moves away from the black-body line (“Planckian locus” or “black body locus”, abbreviated as “BBL”) into the green. Therefore, when dimming prior art metal halide lamps in general, light with an undesired color (temperature) is obtained.

It is desirable to provide an alternative lighting device, comprising at least two light sources, preferably with improved (photometric) properties compared with state of the art lighting devices.

It is desirable to provide a lighting device which is dimmable. When dimming, it is furthermore desirable to have no or no substantial shift of the color point (when dimming the lamp at a constant CCT (correlated color temperature)).

It is furthermore desirable to provide CDM lamps of which the color point can be changed along the black body locus (BBL) without any substantial deviation from the black body locus. When two CDM lamps are used, for example, the rate at which the color point of each individual lamp shifts with changing lamp power is very relevant for the resulting color point of the color variable system, as it is kind of a weighted average of the color points of the two ceramic discharge vessels (burners) in the system.

Hence, according to an aspect of the invention, a lighting device is provided which is dimmable, but without a substantial shift of the color point of the light generated by the lighting device when the lighting device is dimmed or without a substantial deviation of the light generated by the lighting device from the black body locus when the color temperature of the light generated by the lighting device is varied. According to an aspect of the invention, the invention provides a lighting device arranged to generate light, the lighting device comprising:

a) a first light source comprising a first ceramic discharge vessel with two electrodes (enclosed by the first ceramic discharge vessel), the first discharge vessel enclosing a first discharge volume containing a first ionizable gas filling;
b) a second light source comprising a second ceramic discharge vessel with two electrodes (enclosed by the second ceramic discharge vessel), the second discharge vessel enclosing a second discharge volume containing a second ionizable gas filling;
c) the first light source being arranged to generate a first radiation having a first color temperature and the second light source being arranged to generate a second radiation having a second color temperature, the device thereby generating light with a third color temperature;
d) a controller for controlling one or more parameters selected from the group comprising the intensity of the first radiation and the intensity of the second radiation;
e) wherein the first ionizable gas filling comprises one or more components selected from the group comprising LiI, NaI, KI, RbI, CsI, MgI₂, CaI₂, SrI₂, BaI₂, ScI₃, YI₃, LaI₃, CeI₃, PrI₃, NdI₃, SmI₂, EuI₂, GdI₃, TbI₃, DyI₃, HoI₃, ErI₃, TmI₃, YbI₂, LuI₃, InI, TlI, SnI₂, GaI₃ and ZnI₂, wherein the concentration h of the respective components in first discharge vessel in μg/cm³, satisfy the equation:

log h=A/T_{cs}²+B/T_{cs}+C+log z (1)

wherein T_{cs} is the coldest-spot temperature of the first discharge vessel in Kelvin during nominal operation of the first light source, wherein A, B and C are defined in Table 1:

TABLE 1
A, B, C parameters for equation log
h = A/T_{cs}² + B/T_{cs} + C + log z

| Component | A*10⁻⁶ | B*10⁻³ | C |
|---|---|---|---|
| LiI | −0.51 | −5.88 | 7.16 |
| NaI | −1.30 | −5.82 | 6.99 |
| KI | −2.51 | −3.48 | 5.66 |
| RbI | −2.04 | −4.95 | 6.48 |
| CsI | −1.40 | −5.72 | 7.13 |
| MgI₂ | −1.92 | −4.40 | 8.20 |
| CaI₂ | −3.45 | −5.99 | 6.83 |
| SrI₂ | −1.99 | −9.33 | 8.05 |
| BaI₂ | −2.15 | −10.00 | 8.47 |
| ScI3 | −17.70 | 18.76 | 0.16 |
| YI₃ | −7.96 | 0.43 | 6.41 |
| LaI₃ | −4.24 | −4.66 | 6.98 |
| CeI₃ | −3.15 | −7.37 | 9.36 |
| PrI₃ | −1.98 | −7.86 | 8.43 |
| NdI₃ | −4.29 | −4.42 | 6.58 |
| SmI₂ | −1.62 | −11.20 | 9.71 |
| EuI₂ | −1.95 | −10.50 | 8.95 |
| GdI₃ | −9.69 | 4.26 | 3.62 |
| TbI₃ | −9.41 | 4.09 | 3.59 |
| DyI₃ | −11.90 | 6.42 | 4.68 |
| HoI₃ | −9.48 | 3.15 | 5.61 |
| ErI₃ | −12.10 | 6.54 | 5.46 |
| TmI₃ | −3.12 | −5.25 | 7.64 |
| YbI₂ | −1.33 | −10.10 | 8.45 |
| LuI₃ | −9.00 | 3.37 | 5.38 |
| InI | −1.30 | −2.02 | 6.11 |
| TlI | −1.36 | −2.92 | 7.01 |
| SnI₂ | −1.99 | −1.14 | 6.39 |
| GaI₃ | −2.23 | 1.49 | 6.32 |
| ZnI₂ | −2.58 | 0.65 | 5.23 |

and wherein T_{cs} is at least 1100 K and z is between 0.001 and 2.

Such a lighting device according to the invention is found to be a good alternative to existing lighting devices or lamps which are dimmable. In addition, such a lamp is dimmable at a constant CCT without a substantial shift of the color point (i.e. a reduction of the power to below the nominal power preferably results in a shift of the color point within 10 SDCM (standard deviation of color matching)). Furthermore, the color temperature of the light generated by such a lamp can be varied without a substantial deviation from the black body locus (i.e. within 10 SDCM from the black body locus when the color temperature is varied within a range between the first color temperature and the second color temperature). In a preferred embodiment, z is 1 or smaller, such as between 0.01 and 1. In another preferred embodiment, the first ionizable gas filling comprises indium iodide. These and other aspects of the invention will be apparent from and elucidated with reference to the embodiments described herein after.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a ceramic discharge vessel;

FIGS. 2a-b schematically depict embodiments of light sources, without peripheral equipment such as ballasts and power sources;

FIGS. 3a-b schematically indicate how the coldest-spot temperature within the discharge vessel may be estimated;

FIGS. 4a-b schematically depict embodiments of the lighting device according to the invention;

FIG. 5 schematically depicts a further embodiment of the lighting device according to the invention;

FIG. 6 depicts the variations of the color point of a number of lamps, including an embodiment of the first light source for use in the lighting device according to the invention; the first light source for use in the lighting device according to the invention being based on InI in this case;

FIGS. 7a and b schematically depict the color temperature variation achievable with an embodiment of the lighting device according to the invention when the CCT is varied (a) and at a constant CCT (b), respectively;

FIGS. 8a-c show the spectra of a prior art lamp (CCT of about 3000 K) (a), a first light source as described herein (an indium iodide lamp with a CCT of about 6800 K) (b), and a mixed spectrum of the two (CCT about 3900 K) (c) according to an embodiment of the invention, respectively;

FIG. 9 shows the dimmability of the lamp of FIG. 8b at powers of 70-100 W. The ellipse indicates the 5 standard deviation of color matching (5 SDCM) range;

FIG. 10 shows the luminous efficacy and color rendering index (Ra) of the lamp of FIG. 8b at powers of 70-100 W;

FIG. 11 depicts the spectrum of another embodiment of the first light source for use in the lighting device of the invention; the first light source for use in the lighting device according to the invention is based on DyI₃ in this case;

FIG. 12 shows the variation of the color point of the lamp of FIG. 11; and

FIG. 13 shows the variation of the Ra and luminous efficacy of the lamp of FIG. 11.

### DESCRIPTION OF THE PREFERRED EMBODIMENTS

The lighting device of the invention may be described by approximation as a combination of two (or more) specific CDM lamps. For better understanding, discharge vessels of ceramic discharge metal halide lamps will be discussed in general first, then the first light source will be described in more detail, subsequently the second light source will be described, and finally the lighting device and a number of embodiments thereof will be described in more detail. Unless stated otherwise or apparent from the description, definitions given herein, such as “nominal operation” and “coldest-spot temperature”, etc. (see below) apply to both the first light source and the second light source.

### CDM Lamp and Discharge Vessel in General

CDM lamps are sometimes also indicated as CDM HID lamps since CDM lamps belong to the class of HID lamps. The light sources of the lighting device of the invention comprise ceramic discharge vessels (or burners). This especially means that the walls of the ceramic discharge vessel preferably comprise a translucent crystalline metal oxide, like monocrystalline sapphire, and densely sintered polycrystalline alumina (also known as PCA), YAG (yttrium aluminum garnet) and YOX (yttrium aluminum oxide), or translucent metal nitrides like AlN. The vessel wall may consist of one or more (sintered) parts, as known in the art (see also below).

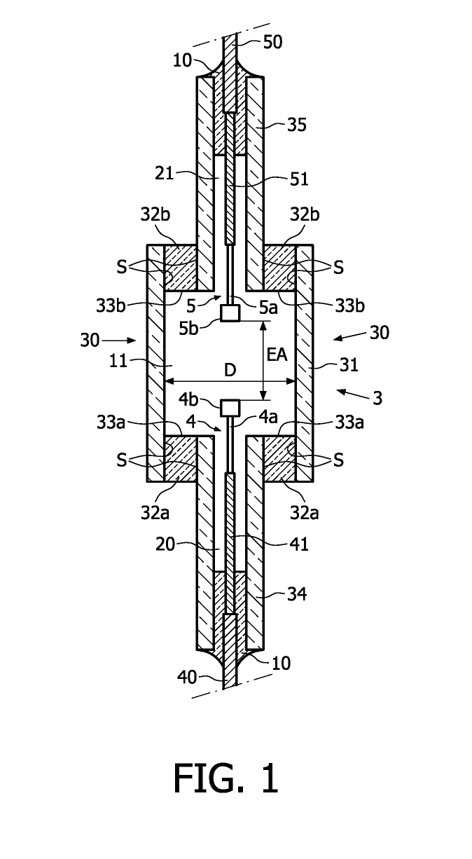

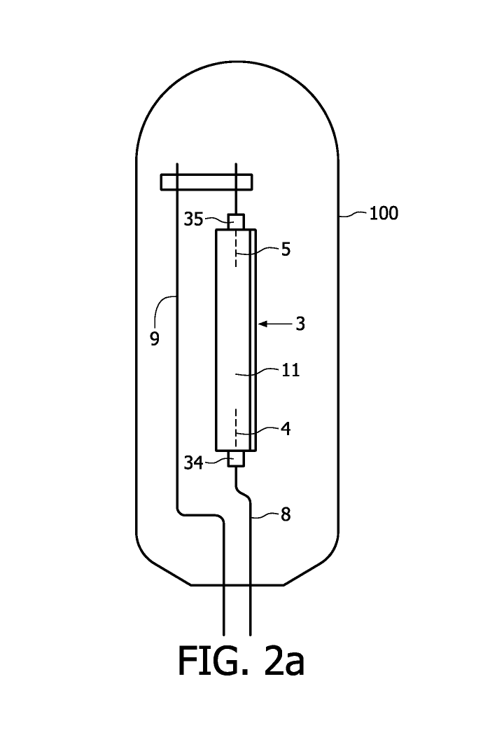

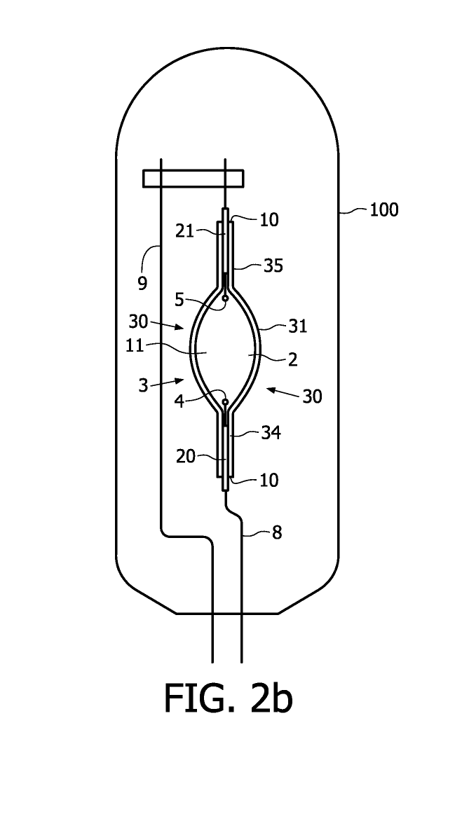

Embodiments of the discharge vessel of the lighting device of the invention will be described below with reference to FIGS. 1-2. However, the light sources and discharge vessels of the lighting device of the invention are not confined to the embodiments described below and/or schematically depicted in FIGS. 1-2. Note that these figures only depict one of the light sources and/or discharge vessels of the lighting device of the invention. The lighting device of the invention, however, comprises two or more of such discharge vessels (also known as “burners”).

In the FIGS. 1-2, discharge vessels 3 are schematically depicted. The current lead-through conductors 20, 21 are sealed with two respective seals 10 (sealing frits, as known in the art). However, the invention is not limited to such embodiments. Lamps (light sources) wherein one or both of the current lead-through conductors 20, 21 are, for example, directly sintered into the discharge vessel 3 may also be applied.

Specific embodiments are described in more detail wherein both current lead-through conductors 20, 21 are sealed by seals 10 into discharge vessel 3. Two electrodes 4, 5, for example tungsten electrodes, with tips 4b, 5b at a mutual distance EA, are arranged in the discharge space 11 so as to define a discharge path between them. The cylindrical discharge vessel 3 has an internal diameter D at least over the distance EA. Each electrode 4, 5 extends inside the discharge vessel 3 over a length forming a tip to bottom distance between the vessel wall 31 (i.e. reference signs 33a, 33b, respectively) and the electrode tip 4b, 5b. The discharge vessel 3 may be closed at either side by means of end wall portions 32a, 32b forming end faces 33a, 33b of the discharge space. The end wall portions 32a, 32b may each have an opening in which ceramic projecting plugs 34, 35 are fitted in a gastight manner in the end wall portions 32a,32b by means of a sintered joint S. The discharge vessel 3 is closed by means of these ceramic projecting plugs 34, 35, which enclose current lead-through conductors 20, 21 (in general comprising components 40, 41 and 50, 51, respectively, which are explained in more detail below) to one of the electrodes 4,5 positioned in the discharge vessel 3 with a narrow intervening space, and is connected to this conductor in a gastight manner by means of a melting-ceramic joint 10 (further indicated as seal 10) at an end remote from the discharge space 11. The ceramic discharge vessel wall 30 here comprises a vessel wall 31, ceramic projecting plugs 34, 35, and end wall portions 32a,32b.

The discharge vessel 3 is surrounded by an outer bulb 100 which in stand-alone lamps is provided with a lamp cap (not depicted) at one end. In an embodiment, the lighting device (see below) may comprise one lamp cap for mounting the entire lighting device (i.e. one lamp cap for the device comprising two light sources). Furthermore, FIGS. 2a and 2b show one discharge vessel 3 per envelope 100; however, in an embodiment, the envelope 100 may comprise more than one discharge vessel (for example both the first and the second discharge vessel). The lighting device will be discussed in more detail further below at “Lighting device”).

A discharge will extend between the electrodes 4 and 5 when the light source is operating. The electrode 4 is connected to a first electrical contact (not depicted) via a current conductor 8. The electrode 5 is connected to a second electrical contact (not depicted) via a current conductor 9.

Each ceramic projecting plug 34, 35 narrowly encloses a current lead-through conductor 20, 21 of an associated electrode 4, 5 having an electrode rod 4a, 5a provided with a tip 4b, 5b. Current lead-through conductors 20, 21 enter the discharge vessel 3. The current lead-through conductors 20, 21 may each comprise a halide-resistant portion 41, 51 in an embodiment, for example in the form of a Mo—Al₂0₃ cermet and a portion 40, 50 which is fastened to a respective end plug 34, 35 in a gastight manner by means of seals 10. Seals 10 extend over some distance, for example approximately 1 to 5 mm, over the Mo cermets 41, 51 (ceramic sealing material penetrates into the free space within the end plugs 34,35 during sealing). It is possible for the parts 41, 51 to be formed in an alternative manner instead of from a Mo—Al₂0₃ cermet. Other possible constructions are known, for example, from EP 0 587 238 (incorporated herein by reference, wherein a Mo coil-to-rod configuration is described). A particularly suitable construction was found to be a halide-resistant material. The parts 40, 50 are made from a metal whose coefficient of expansion corresponds very well to that of the end plugs 34, 35. Niobium (Nb) is chosen, for example, because this material has a coefficient of thermal expansion corresponding to that of the ceramic discharge vessel 3.

FIGS. 2a and 2b show two different embodiments, wherein the discharge vessel 3 in FIG. 2a is similar to the discharge vessel depicted in FIG. 1. Corresponding lamp parts have been given the same reference numerals in FIGS. 1 and 2. FIG. 2b shows an alternative discharge vessel. The discharge vessel 3 has a shaped wall 30 enclosing the discharge space 11. The shaped wall 30 forms an ellipsoid in the present case. Compared with the embodiment described above (see also FIGS. 1 and 2a), the wall 30 is a single entity, in fact comprising wall 31, end plugs 34, 35, and end wall portions 32a, 32b (shown as separate parts in FIG. 2). A specific embodiment of such a discharge vessel 3 is described in more detail in WO06/046175. Alternative shapes, for example spheroid, are equally possible.

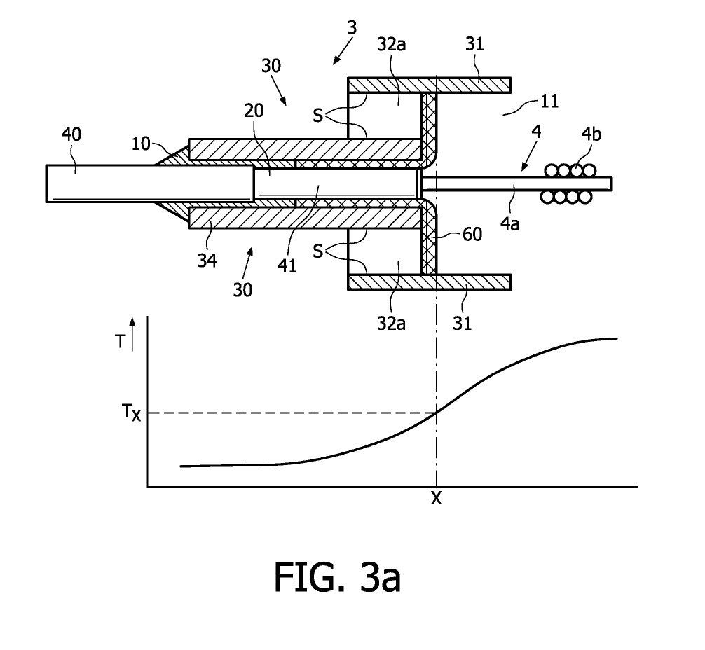

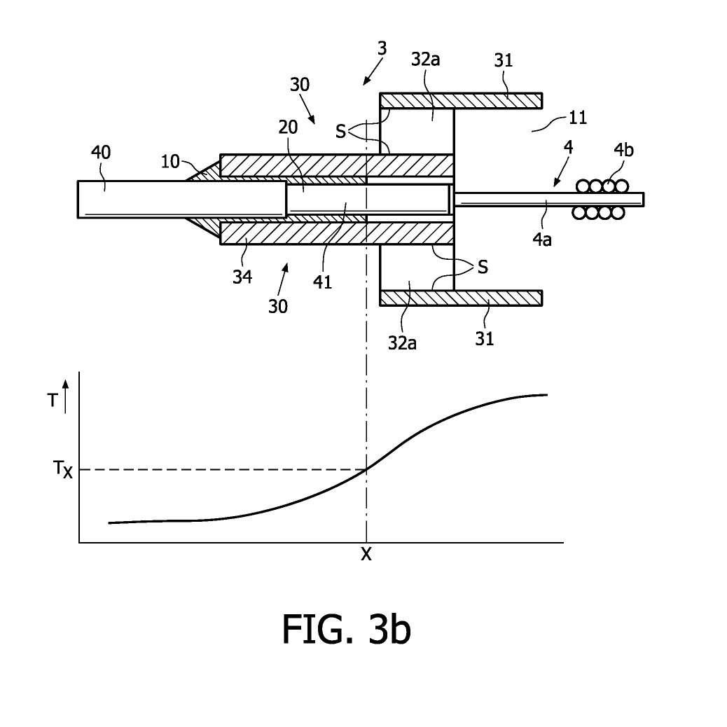

The wall 30, which in the embodiment schematically depicted in FIG. 1 may include ceramic projecting plug 34, 35, end wall portions 32a, 32b, and wall 31 or wall 30, as schematically depicted in FIG. 3, is a ceramic wall here, which is to be understood to mean a wall of translucent crystalline metal oxide or translucent metal nitrides like AlN (see also above). According to the state of the art, these ceramics are well suited to form translucent discharge vessel walls of vessel 3. Such translucent ceramic discharge vessels 3 are known, for example, from EP215524, EP587238, WO05/088675, and WO06/046175. In a specific embodiment, the discharge vessel 3 comprises translucent sintered Al₂O₃, i.e. the wall 30 comprises translucent sintered Al₂O₃. In the embodiment schematically depicted in the figures, wall 30 may alternatively comprise sapphire.

Part of the discharge vessel 3 of FIG. 1 is depicted in more detail in FIGS. 3a-b. The horizontal orientation does not necessarily imply that the light sources are to be applied in this orientation. In this figure, the presence of condensed material for the ionizable gas filling is referenced 60 (as it is the case for prior art lamps, even when such prior art lamps are operated at maximum power). FIG. 3a schematically depicts a situation where the voids between electrode 4 and projecting end plug 34 contain condensed material (such as iodide salts) even during operation of the lamp. This is especially a situation that may be found in known lamps, since such lamps mainly use oversaturated fillings. During operation of prior art high pressure discharge lamps, condensed material is still present in the discharge vessel. This leads to a situation that the discharge gas is saturated with iodides during operation, and a metal halide salt “pool” is formed at the coldest spot.

Characteristic mean temperatures and pressures of the gas within the discharge vessel 3 during operation are about 2000-3000 K, such as about 2500 K, and about 2-50 bar, respectively. However, there are temperature differences within the discharge vessel 3. The temperature will be relatively high close to electrode tips 4b, 5b. During operation the temperature within the discharge vessel may vary from as high as about 6000 K in the core of the arc to a characteristic temperature of about 3000 K at the electrode tip, and to a characteristic temperature of about 1600 K of the hottest part of the discharge vessel wall 30 to a characteristic temperature near, for example, an end part of the discharge vessel 3, the so cold coldest-spot temperature (see also above). In general, the temperature will be lower at (the end of) projecting plugs 34, 35 than at the internal surface of wall 30 (FIG. 2b) or wall 31 (FIG. 1), see also FIG. 3b. The place within discharge vessel 3 with the lowest temperature is indicated as coldest spot, and its temperature is sometimes indicated as T_{cs} or Tₖₚ (see EP 0 215 524).

The coldest spot can be determined by measuring the local wall temperature of wall 30 of discharge vessel 3, see for example W. van Erk, Pure Appl. Chem. 72(11) 2000, pp. 2159-2166. The lowest temperature measured (at the outside of wall 30) is called the coldest-spot temperature. This determination is known in the art and is briefly illustrated below.

FIG. 3b schematically shows the same part of the discharge vessel 3 as schematically indicated in FIG. 3a, with a schematic indication of the temperature gradient. The discharge vessel 3 encloses a volume 11, i.e. the volume wherein the components of the gas filling are present and wherein these components form the gas during use of the lamp 1. In the embodiment of FIG. 3b, this volume is the volume enclosed by wall 30, i.e. wall 31, end parts 32a (only one side of the discharge vessel 3 is shown in this schematic figure), projecting plug 34, and seal 10 (see also FIGS. 1 and 2b). The temperature along wall 30 can be determined by measuring the emission of the ceramic material, or by other methods known in the art. This temperature is indicated as function of position x. In the schematic FIG. 3b, the coldest spot is found at the end of the ceramic projecting plug 34, i.e. where the discharge volume 11 ends and the seal 10 starts. This position is indicated with x, and the temperature at this point, the coldest-spot temperature within discharge vessel 3, is indicated with Tₓ. This temperature Tₓ (i.e. T_{cs}) is at least 1100 K during operation, at least during nominal operation. The position of the coldest spot depends on the orientation of the lamp 1 (such as a horizontal or vertical orientation). The schematic drawing of FIG. 3a represents to a prior art situation with a large supersaturation (such a situation may also be found, for example, for the second (or further) discharge vessel (see below)), but the schematic drawing of FIG. 3b relates to the first discharge vessel of the lighting device according to the invention, wherein substantially no condensation of the gas filling components takes place during nominal operation of the first discharge vessel (vide infra).

### The First Light Source

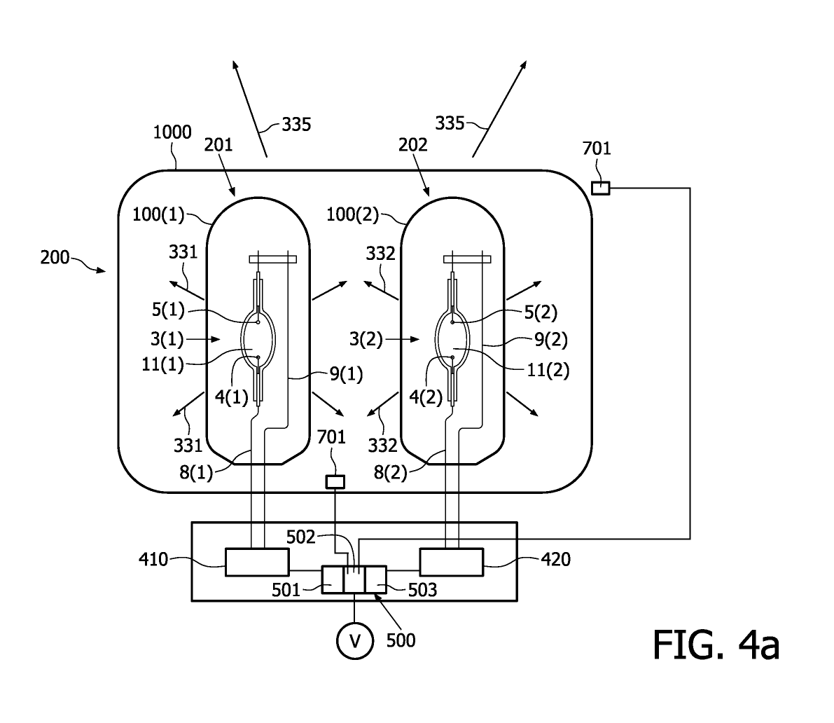

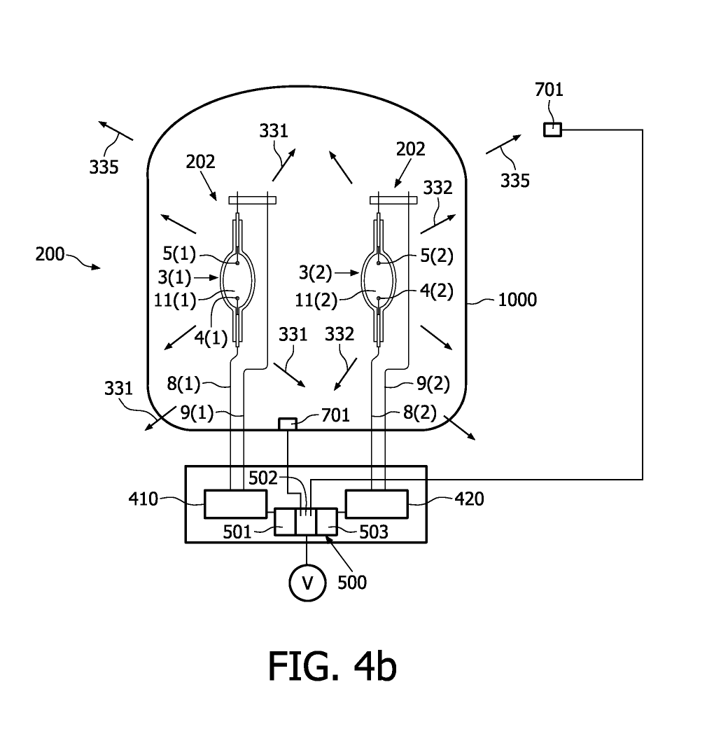

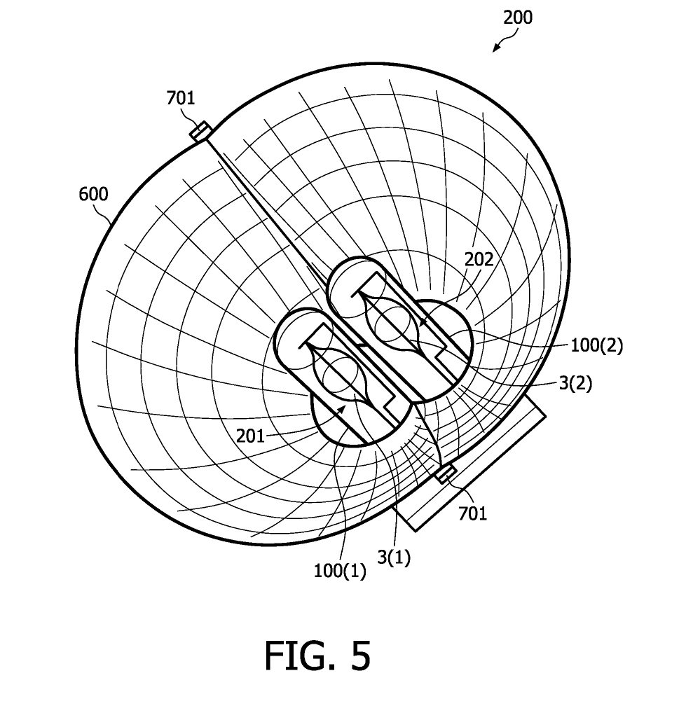

Referring to the general embodiments of light sources and ceramic discharge vessels 3 schematically depicted in FIGS. 1, 2, and 3b, and the specific embodiments of the lighting device according to the invention schematically depicted in FIGS. 4 and 5 (vide infra), the first light source 201 comprises a first ceramic discharge vessel 3(1) with two electrodes 4(1), 5(1), the first discharge vessel 3(1) enclosing a first discharge volume 11(1) containing a first ionizable gas filling. The discharge vessel 3(1) may be circumferentially surrounded by an envelope or bulb 100(1), or may alternatively be included together with a second light source 202 in one envelope or “bulb” 1000 (vide infra).

The ionizable filling in the lamp 1 of the invention preferably comprises InI, although also gas fillings based on other components may be used. In addition to InI and/or one or more of the other components of the first ionizable gas filling described herein, the discharge space 11(1) (but also 11(2), see below) contains Hg (mercury) and a starter gas such as Ar (argon) or Xe (xenon), as known in the art. Characteristic Hg amounts are between about 1 and 100 mg/cm³ Hg, especially in the range of about 5-20 mg/cm³ Hg. Characteristic pressures are in the range of about 2-50 bar. Preferably, the amount of mercury in the discharge vessel 3(1) is chosen to provide a mercury gas at nominal use without condensation of mercury, i.e. the mercury vapor is unsaturated. Mercury and a starter gas are known to those skilled in the art and are not further discussed. In principle, the first and second light sources of the lighting device of this invention may also be operated without mercury, but in the preferred embodiments Hg is present in the discharge vessel 3(1). During steady-state burning, long-arc lamps in general have a pressure of a few bar, whereas short-arc lamps may have pressures in the discharge vessel of up to about 50 bar. Characteristic lamp powers are between about 10 and 1000 W, preferably about 20-600 W.

The phrase “coldest-spot temperature of at least 1100 K during use of the light source” refers to the temperatures within discharge vessel 3(1) during use of the light source 201 in the lighting device 200 according to the invention, indicating that the temperature at the coldest spot within discharge vessel 3(1) is at least 1100 K during use of the light source 201 in the lighting device 200. It especially refers to the operation of the light source at maximum power, i.e. nominal operation. In the invention, the coldest-spot temperature in the first discharge vessel (3(1) of the first light source 201 at nominal operation is at least about 1100 K, preferably even higher. During start-up or, for example, dimming, the coldest-spot temperature may be lower, however.

Herein, the term “nominal operation” and similar terms refer to the operation of the first light source 201 at the rated power. For example, a commercially available lamp of 50 W (i.e. rated at 50 W) is used nominally at 50 W. Equivalent terms for “nominal operation” known in the art are “rated power”, “maximum power”, “operation at maximum power”, “operation at nominal power”, “nominal use”, or “nominal power”. The term “during operation” refers to the situation wherein the first light source 201 is operating, especially at the prescribed conditions such as environment temperature, indicated power, current, and frequency. Hence, “nominal operation” or “maximum power”, etc., herein denote operation of the light source(s) at the maximum power and under conditions for which the light source(s) was (were) designed to be operated. It especially refers to the situation wherein the first light source 201 is operating at a substantially constant level after an initial start-up, for example after about 1 minute (steady state). Then, the first light source 201 is used in stable operation owing to the presence of a stable arc. The term “unsaturated” refers to the situation wherein the gas within the discharge vessel 3(1) during nominal (undimmed) operation is unsaturated with respect to the ionizable gas filling components, as indicated herein. This means that, during operation at nominal power, substantially no iodides of the rare earth(s) or other gas filling components condense at the internal surface of the discharge vessel 3(1) or other elements which are arranged within discharge vessel 3(1). Hence, substantially all components within discharge vessel 3(1) are in the gas phase during nominal operation of the first light source 201.

In an embodiment, the present invention provides a first discharge vessel 3(1) of the first light source 201 wherein the ionizable filling components are dosed in such small amounts that no or substantially no condensation of filling components will occur during operation of the lamp, especially during nominal operation of the lamp (i.e. first light source 201). Hence, the ionizable filling components are preferably present in discharge vessel 3(1) in an amount such that a substantially unsaturated gas is obtained during nominal operation. This implies that, during nominal operation of the first light source 201, preferably no or substantially no condensed components of the ionizable gas filling, like REIₙ and/or InI, are found within discharge vessel 3(1).

Favorable conditions are especially achieved in an embodiment by selecting a specific concentration for the components and by selecting the appropriate coldest-spot temperature within discharge vessel 3(1) at nominal operation, see also Table 2 below.

The concentration of the respective components can be calculated from the above equation, and the ceramic discharge vessel 3(1) and first light source 201 can be arranged to have a coldest-spot temperature at nominal operation of a predetermined value (which is at least 1100 K). The term “respective components” refer to the fact that the concentration has to be calculated for each individual component of the gas filling, which contains one or more components selected from the group of LiI, NaI, KI, RbI, CsI, MgI₂, CaI₂, SrI₂, BaI₂, ScI₃, YI₃, LaI₃, CeI₃, PrI₃, NdI₃, SmI₂, EuI₂, GdI₃, TbI₃, DyI₃, HoI₃, ErI₃, TmI₃, YbI₂, LuI₃, InI, TlI, SnI₂, GaI₃, and ZnI₂, in accordance with the above equation and the parameters given in Table 1. It is found that the advantages of the invention over prior art lamps can be obtained when the concentrations of the respective components of the gas filling satisfy equation (1) and the values of the parameters A, B, C, z, and T_{cs} given above. Standard filling components Hg and a starter gas are not included in the Table; these filling components are in the gas phase during operation (see also above).

Especially good photometric properties are obtained with a concentration h wherein z is 2 or smaller. Especially in the preferred embodiment wherein z is 1 or smaller, the filling components are in the gas phase during nominal operation. In general, the lower z, the less the properties of the lamp depend upon its thermal loading.

In general, prior art lamps may have a coldest-spot temperature of about 900-1100 K during use. Temperatures higher than about 1100 K can only be achieved in ceramic discharge vessels 3(1) (or (3(2)), since the quartz of quartz vessels deteriorates at temperatures above about 1100 K. The temperature of the coldest spot in discharge vessel 3(1) of the first light source 201 according to the invention in a preferred general condition, however, is at least about 1100 K during nominal operation. In a specific embodiment, the coldest-spot temperature (or minimum temperature) is between about 1100 and 1600 K during nominal operation. Especially good results are obtained when discharge vessel 3(1) is arranged to have a coldest-spot temperature of at least about 1200 K during operation at nominal power of the lamp, preferably at least about 1300 K, more preferably at least about 1350 K, even more preferably at least about 1400 K, i.e. the coldest-spot temperature is at least about 1300 K, 1350 and 1400 K in nominal operation, respectively. In a more specific embodiment, the discharge vessel 3(1) is arranged to have a coldest-spot temperature in the range of 1350-1500 K during nominal operation of the first light source 201. In general, it is found that the higher the coldest-spot temperature, the more the first light source 201 is dimmable. It is further found that the higher the coldest-spot temperature, the more independent the first light source 201 is of the external temperature or orientation of the discharge vessel 3(1). The phrase “the discharge vessel 3(1) is arranged to have a coldest-spot temperature of at least 1200 K” refers to the design of the lighting device 200, first light source 201, and discharge vessel 3(1) which renders it possible for the first light source 201 to have the coldest-spot temperatures as mentioned herein for the coldest spot during operation (especially at nominal use). When dimming the lighting device 200 to powers lower than nominal power (i.e. lower than the rated power), the temperature of the coldest spot may decrease. Depending on the concentration, this may lead to condensation of one or more components of the filling. Hence, T_{cs} may vary during operation, depending upon the selected power (100% or lower). The filling concentration, however, is calculated with respect to operation at nominal power. A T_{cs} value of at least 1100 K or higher is obtained for the first light source 201 during such nominal operation.

In a specific embodiment, however, a salt concentration h (of one or more of the components of the gas filling) is selected that is about 10% or lower, more preferably 1% or lower, of the saturation concentration (z is about 1, or lower) of the first light source 201 at its maximum output (i.e. nominal operation), i.e. z is 0.1 or 0.01 (or lower), respectively. In this way condensation can be substantially prevented even during dimming. Assuming that a DyI₃ filling of 46.90 μg/cm³ (z=0.01) and a coldest-spot temperature at nominal operation of 1500 K leads, for example, to a lowering of the coldest-spot temperature to about 1200 K, the DyI₃ concentration would still be below saturation even during dimming (see also Table 2 below). Hence, such lamps (i.e. first light source 201) will in general be dimmable for at least 30% of their maximum power without a substantial worsening of their photometric properties such as (a substantial) shift of the color point (see also below).

Table 2 gives a preferred maximum concentration at a specific temperature for a number of iodides. In this Table, the amount in μg/cm³ that can be added to the first discharge vessel 3(1) (without resulting in partially condensed substances during operation at maximum power of the first light source 201) so as to provide an unsaturated gas (with respect to the specific iodide) is given for a number of iodides, if the coldest-spot temperature in the first light source 201 exceeds the temperatures indicated (1100 K, 1200 K, 1300 K, 1400 K, 1500 K and 1600 K). A preferred value in this Table is z=1.

TABLE 2
embodiments of maximum concentration (μg/cm³)
of REIₙ, InI, NaI, and other iodides.

| Component | 1100 K | 1200 K | 1300 K | 1400 K | 1500 K | 1600 K |
|---|---|---|---|---|---|---|
| LiI | 2.48*10¹ | 8.06*10¹ | 2.17*10² | 5.02*10² | 1.03*10³ | 1.93*10³ |
| NaI | 4.23 | 1.73*10¹ | 5.56*10¹ | 1.48*10² | 3.41*10² | 7.01*10² |
| KI | 2.64 | 1.04*10¹ | 3.15*10¹ | 7.83*10¹ | 1.68*10² | 3.20*10² |
| RbI | 3.69 | 1.54*10¹ | 4.97*10¹ | 1.31*10² | 2.97*10² | 5.98*10² |
| CsI | 5.93 | 2.46*10¹ | 7.97*10¹ | 2.14*10² | 4.95*10² | 1.02*10³ |
| MgI₂ | 4.10*10² | 1.58*10³ | 4.78*10³ | 1.20*10⁴ | 2.59*10⁴ | 5.01*10⁴ |
| CaI₂ | 3.41*10⁻² | 2.77*10⁻¹ | 1.51 | 6.18 | 2.01*10¹ | 5.47*10¹ |
| SrI₂ | 8.39*10⁻³ | 7.82*10⁻² | 4.96*10⁻¹ | 2.35 | 8.82 | 2.76*10¹ |
| BaI₂ | 4.00*10⁻³ | 4.40*10⁻² | 3.20*10⁻¹ | 1.70 | 7.04 | 2.40*10¹ |
| ScI₃ | 3.78*10² | 3.12*10³ | 1.29*10⁴ | 3.33*10⁴ | 6.20*10⁴ | 9.20*10⁴ |
| YI₃ | 1.66 | 1.73*10¹ | 1.07*10² | 4.50*10² | 1.43*10³ | 3.69*10³ |
| LaI₃ | 1.73*10⁻¹ | 1.41 | 7.67 | 3.06*10¹ | 9.70*10¹ | 2.57*10² |
| CeI₃ | 1.16 | 1.09*10¹ | 6.80*10¹ | 3.12*10² | 1.13*10³ | 3.38*10³ |
| PrI₃ | 4.52*10⁻¹ | 3.25 | 1.65*10¹ | 6.48*10¹ | 2.07*10² | 5.62*10² |
| NdI₃ | 1.04*10⁻¹ | 8.25*10⁻¹ | 4.37 | 1.71*10¹ | 5.32*10¹ | 1.38*10² |
| SmI₂ | 1.55*10⁻² | 1.79*10⁻¹ | 1.37 | 7.65 | 3.34*10¹ | 1.19*10² |
| EuI₂ | 6.21*10⁻³ | 7.01*10⁻² | 5.24*10⁻¹ | 2.85 | 1.21*10¹ | 4.22*10¹ |
| GdI₃ | 3.08*10⁻¹ | 2.78 | 1.47*10¹ | 5.28*10¹ | 1.43*10² | 3.16*10² |
| TbI₃ | 3.35*10⁻¹ | 2.87 | 1.45*10¹ | 5.07*10¹ | 1.35*10² | 2.92*10² |
| DyI₃ | 4.80 | 5.84*10¹ | 3.78*10² | 1.56*10³ | 4.69*10³ | 1.11*10⁴ |
| HoI₃ | 4.35 | 4.48*10¹ | 2.65*10² | 1.05*10³ | 3.14*10³ | 7.51*10³ |
| ErI₃ | 2.51*10¹ | 3.17*10² | 2.12*10³ | 8.97*10³ | 2.74*10⁴ | 6.54*10⁴ |
| TmI₃ | 1.98 | 1.27*10¹ | 5.78*10¹ | 2.01*10² | 5.74*10² | 1.40*10³ |
| YbI₂ | 1.50*10⁻² | 1.31*10⁻¹ | 7.94*10⁻¹ | 3.66 | 1.35*10¹ | 4.21*10¹ |
| LuI₃ | 9.96 | 8.54*10¹ | 4.37*10² | 1.54*10³ | 4.17*10³ | 9.21*10³ |
| InI | 1.58*10³ | 3.34*10³ | 6.12*10³ | 1.01*10⁴ | 1.53*10⁴ | 2.19*10⁴ |
| TlI | 1.71*10³ | 4.29*10³ | 9.11*10³ | 1.70*10⁴ | 2.88*10⁴ | 4.51*10⁴ |
| SnI₂ | 5.12*10³ | 1.14*10⁴ | 2.17*10⁴ | 3.63*10⁴ | 5.57*10⁴ | 7.95*10⁴ |
| GaI₃ | 3.80*10⁵ | 6.79*10⁵ | 1.03*10⁶ | 1.40*10⁶ | 1.76*10⁶ | 2.10*10⁶ |
| ZnI₂ | 4.83*10³ | 9.46*10³ | 1.58*10⁴ | 2.37*10⁴ | 3.26*10⁴ | 4.22*10⁴ |

The above values in Table 2 are preferred values for the upper limits for the concentration in discharge vessel 3(1) of the respective compounds in the first light source 201 of lighting device 200, wherein the minimum temperature (coldest-spot temperature) within discharge vessel 3(1) is as indicated in the Table, at least during nominal operation. For example, assuming a preferred embodiment with a coldest-spot temperature in the discharge vessel 3(1) of 1300 K, i.e. the coldest-spot temperature in discharge vessel 3(1) is 1300 K or higher, and with (only) InI as the ionizable gas (in addition to mercury gas and a noble gas), a preferred maximum concentration is about 6120 μg/cm³ (z=1). If the coldest-spot temperature during nominal operation is, for example, 1400 K, a concentration of more than about 10,100 μg/cm³ may lead to condensation of InI in the discharge vessel 3(1), whereas a concentration of 10,100 μg/cm³ InI or less will lead to a substantially unsaturated filling with respect to the InI component when the light source 201 is operated at maximum power.

In Table 2, z=1, a preferred value. In this way, the disadvantages of largely oversaturated gas filling components are avoided, while the good photometric properties of the invention are achieved. The values in Table 2 may be interpreted as preferred maximum concentrations at the respective coldest-spot temperatures indicated in Table 2 during nominal operation. In embodiments of the invention, the concentrations may also be lower than indicated in Table 2. Preferred maximum values are those indicated in the 1300 K column.

It was further found that, given the condition that the gas filling is substantially unsaturated, parameters such as discharge vessel geometry are less important than for state of the art lamps. Further, when the temperature of the coldest spot is high enough, effects of the lamp orientation (i.e. orientation of the tint light source 201), ambient temperature, luminaire, etc., are of minor importance. This is also of relevance in view of the relatively close presence of the second light source (see below). This means, furthermore, that the conditions defined herein may give those skilled in the art more freedom in an embodiment to design the first discharge vessel 3(1) than might be possible for discharge vessels of lamps that are conventionally operated.

It is further found that the higher the temperature, and the lower the salt concentration with respect to the saturation concentration, the better the light source 201 is dimmable, which again results in a better dimming behavior of the complete lighting device 200. Characteristic ranges in which the first light source 201 according to an embodiment of the invention can be dimmed are from 100% (no dimming) of its intensity at nominal operation down to about 70%, more preferably to 50% of its intensity at nominal operation. In an embodiment, the first metal halide lamp 201 of the device 200 according to the invention is dimmable, especially within a range of 100 (undimmed) to 70%, more preferably 100 to 50% of its intensity at nominal operation without a substantial shift of the color point. Herein, the term “without a substantial shift of the color point” refers to a shift of the color point which is not greater than 10 SDCM, especially not greater than 5 SDCM. A preferred tolerance is not greater than about 2 to 5 SDCM.

Preferably, the first light source 201 generates radiation 331 with a color point close to or on the BBL (i.e. preferably within about 10 SDCM) at least at maximum power (i.e. intensity at nominal operation; see also below). When such lamp is dimmed, the color point preferably stays close to the BBL over a power range of about 100% to 70%, more preferably 50% (or even less) of the intensity at nominal operation (i.e. maximum power).

The first light source 201 preferably has a high color temperature, i.e. at least 5000 K, even more preferably at least about 6000 K. This renders it possible for a lighting device 200 according to the invention (a) to be dimmable at constant CCT without a substantial shift of the color point and (b) to have a color temperature of the light that can be varied without a substantial deviation from the black body locus.

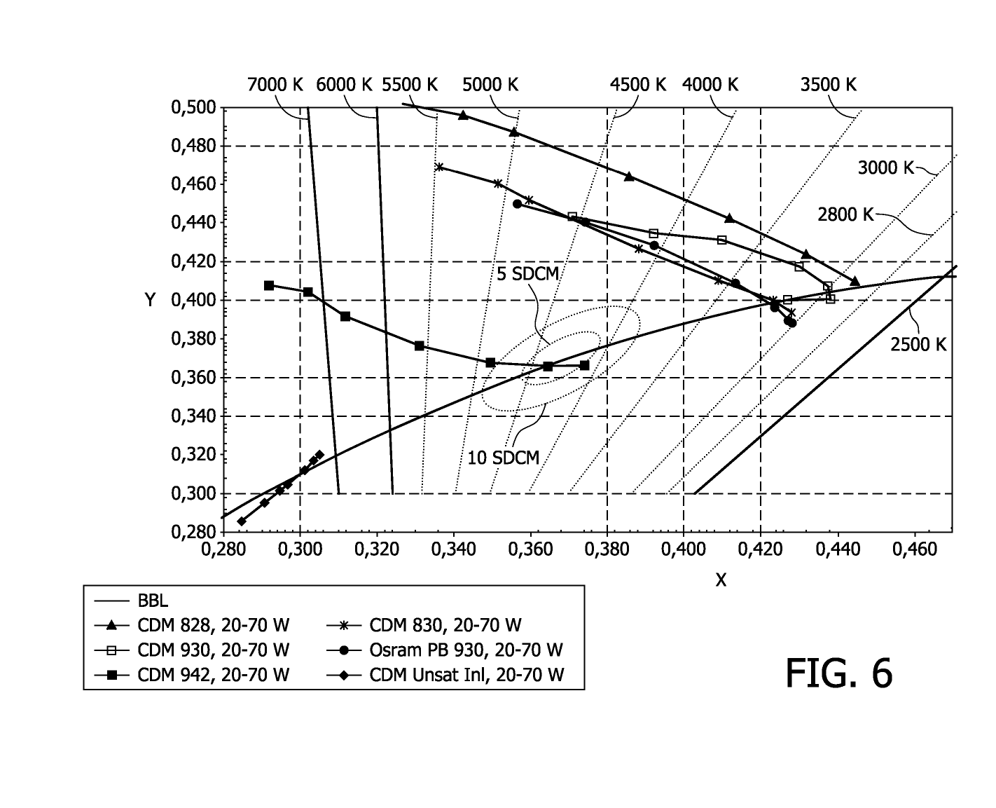

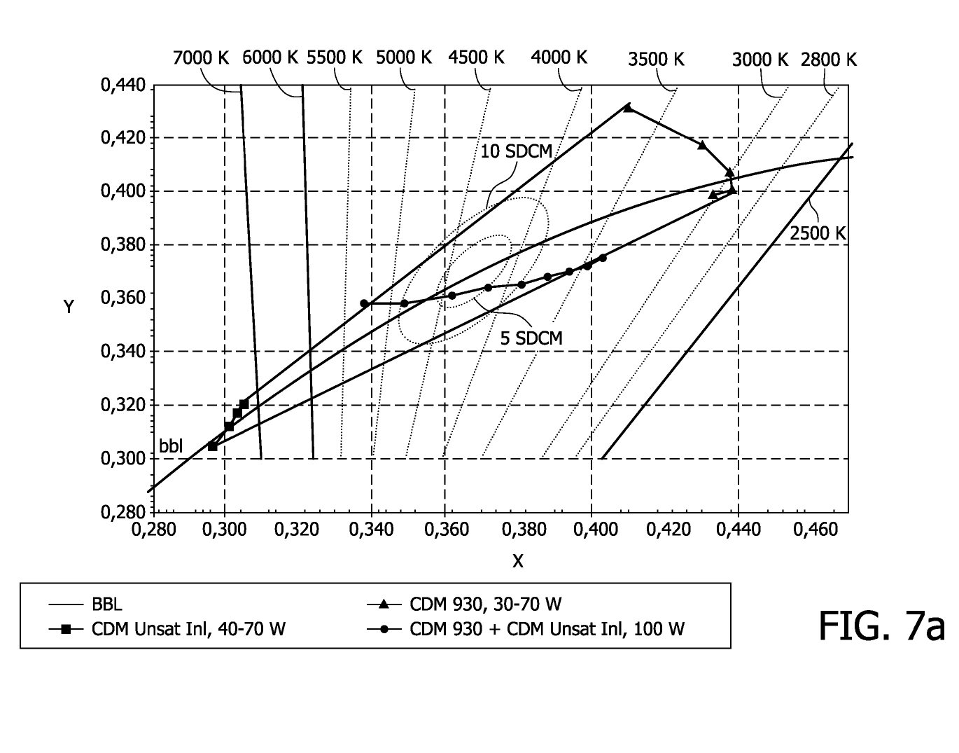

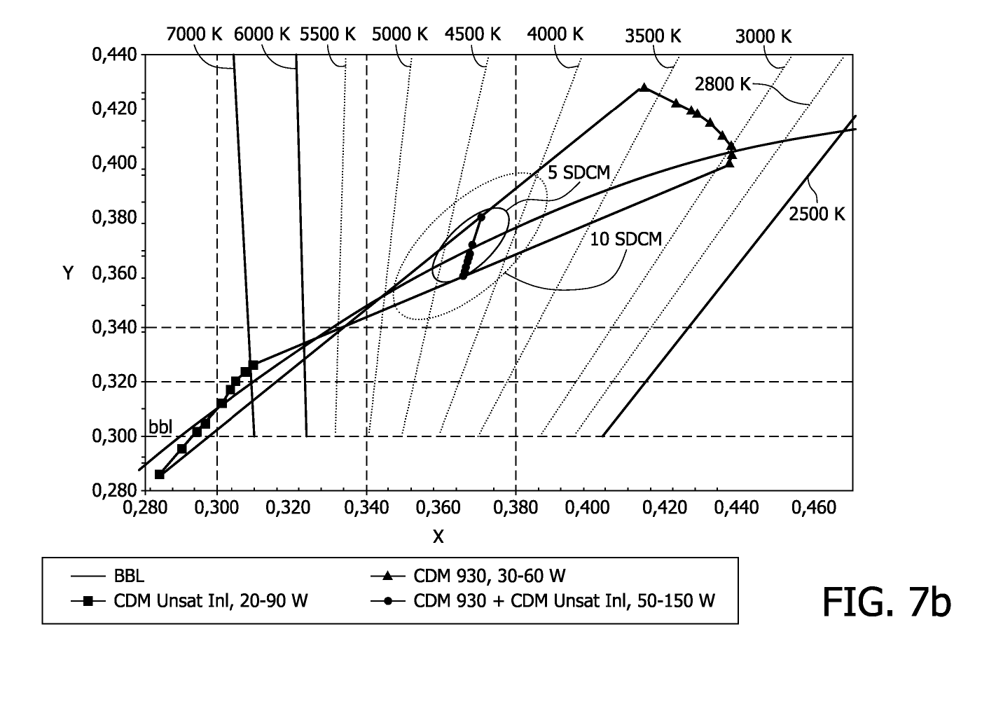

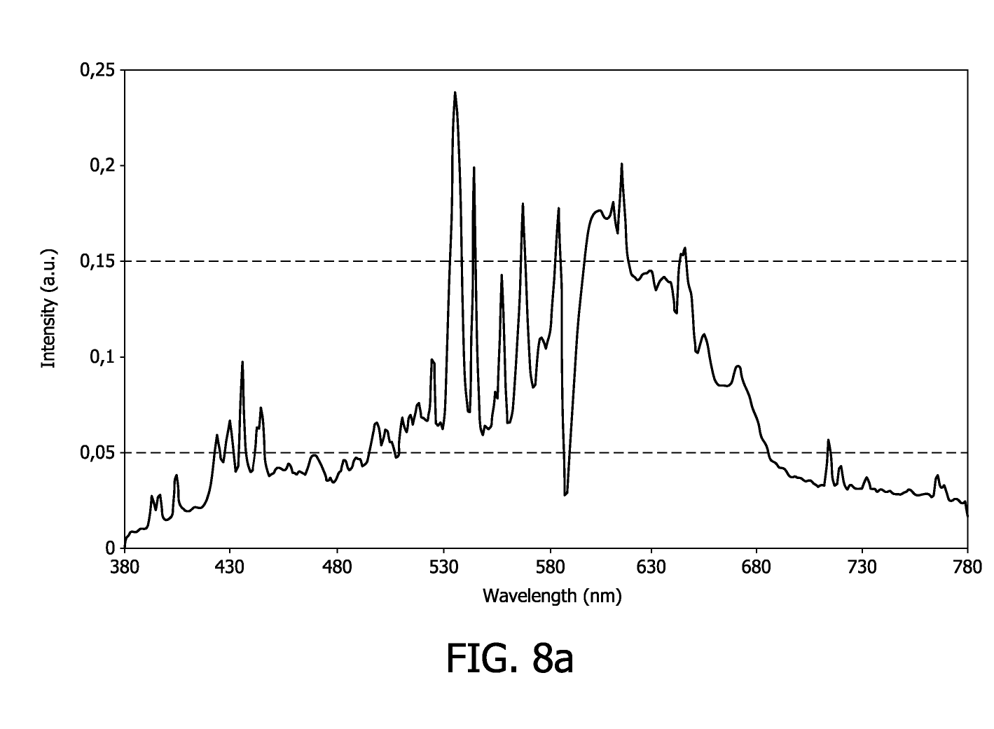

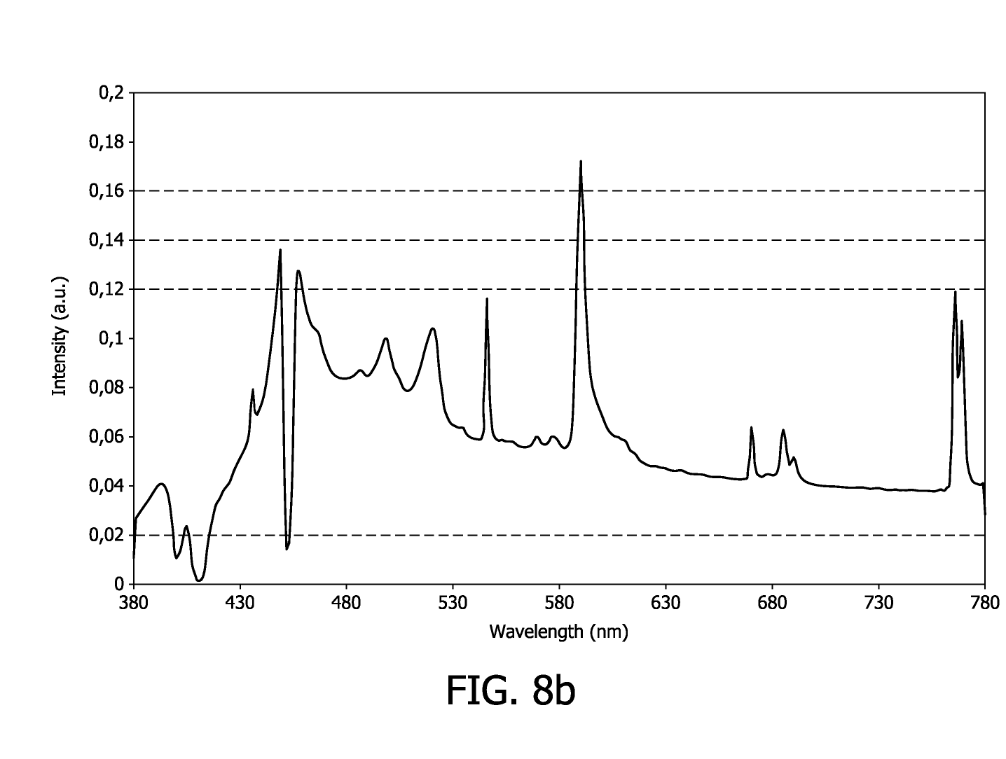

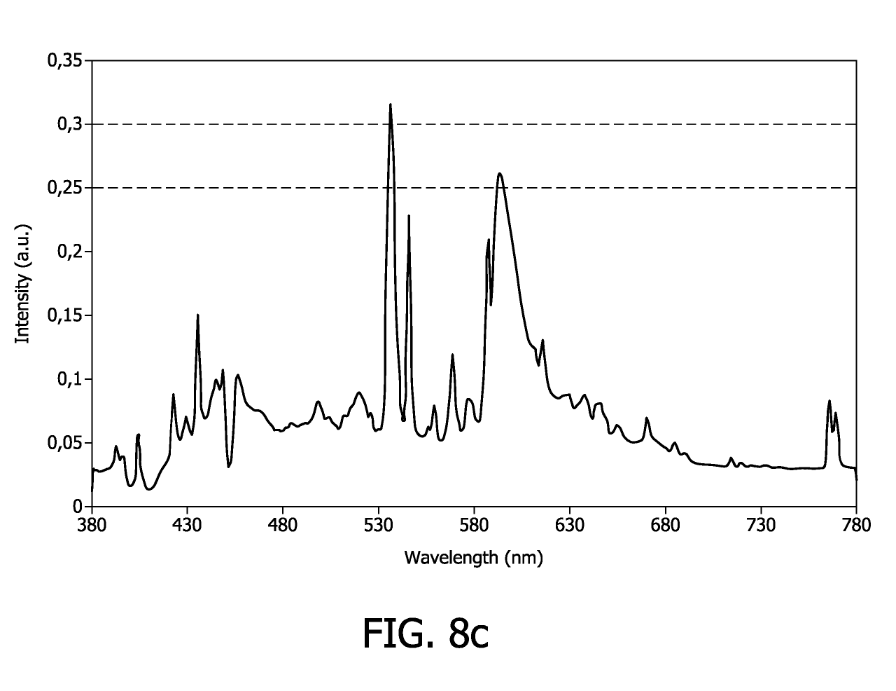

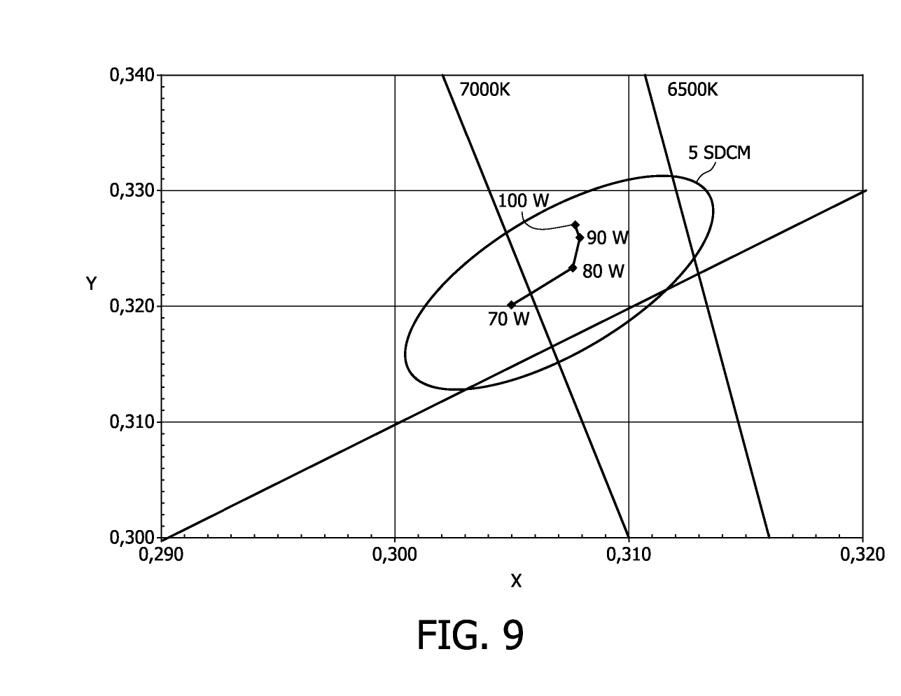

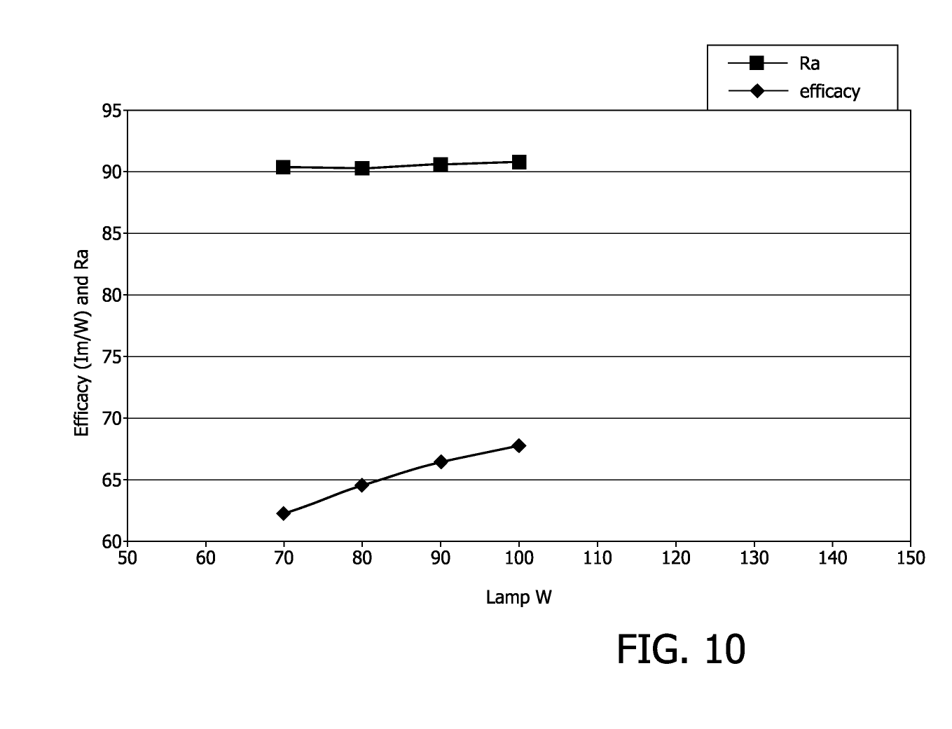

As mentioned above, a specific embodiment of the first light source 201 is an InI-based light source 201. An emission spectrum of an InI-based light source 201, fulfilling the above equation, is shown in FIG. 8b; the relation of the color point, efficacy and Ra as a function of the power are shown in FIGS. 9 and 10, respectively. The influence of dimming the InI light source 201 on the color point/color temperature is also shown in FIGS. 6 and 7. FIG. 6 shows the dimming behavior of a number of prior art lamps and of an InI-based lamp used as a first light source 201 in the lighting device 200 according to the invention (see also the Examples).

An InI-based lamp which satisfies the above equation is especially preferred as the first light source 201 because of its high color point and its color stability when dimming. A (first) light source having a relatively high (first) color temperature other than the one based on InI (as described in the embodiment above) may be a (first) light source 201 based on GaI₃. Light sources based on GaI₃ also have relatively high color temperatures.

### The Second Light Source

Referring to the general embodiments of light sources and ceramic discharge vessels 3 schematically depicted in FIGS. 1,2 and 3a-b, and the specific embodiments of the lighting device according to the invention schematically depicted in FIGS. 4 and 5 (vide infra), the second light source 202 comprises a second ceramic discharge vessel 3(2) with two electrodes 4(2), 5(2) and a second discharge vessel 3(2) enclosing a second discharge volume 11(2) containing a second ionizable gas filling. The discharge vessel 3(2) may be circumferentially surrounded by an envelope or bulb 100(2) or it may be included together with the first light source 201 in one envelope or “bulb” 1000 (see also below).

As in the first light source 201, the discharge space 11(2) contains Hg (mercury) and a starter gas such as Ar (argon) or Xe (xenon), as known in the art. Characteristic Hg amounts are between about 1 and 100 mg/cm³ Hg, especially in the range of about 5-20 mg/cm³ Hg; characteristic pressures are in the range of about 2-50 bars. Preferably, the amount of mercury in the discharge vessel 3(2) is chosen to provide a mercury gas at nominal use without condensation of mercury, i.e. the mercury vapor is unsaturated. Mercury and a starter gas are known to those skilled in the art and are not further discussed. In principle, the second light source 202 can also be operated without mercury, but in the preferred embodiments Hg is present in the discharge vessel 3(2). During steady state burning, long-arc lamps in general have a pressure of a few bar, whereas short-arc lamps may have pressures in the discharge vessel of up to about 50 bar. Characteristic powers of the lamp are between about 10 and 1000 W, preferably in the range of about 20-600 W.

Assuming that the first light source 201 is a light source which satisfies the above equation, the second light source may be any CDM lamp in principle. Hence, the second light source 202, which is also a ceramic discharge lamp, may have any filling known in the art in principle (for further specific conditions, see below at “lighting device”). For example, referring to the description above for the first light source 201, the filling of the second light source 202 may comprise components other than those described above and/or z may also be above 2. The coldest-spot temperature in the discharge vessel 3(2) may be higher but may also be lower during operation of the second light source 201 at maximum power. The advantages described herein result from the use of (at least) two CDM lamps of which at least one fulfils the criteria described above for the first light source 201.

Preferably, the second ionizable gas filling also comprises one or more components selected from the group consisting of LiI, NaI, KI, RbI, CsI, MgI₂, CaI₂, SrI₂, BaI₂, ScI₃, YI₃, LaI₃, CeI₃, PrI₃, NdI₃, SmI₂, EuI₂, GdI₃, TbI₃, DyI₃, HoI₃, ErI₃, TmI₃, YbI₂, LuI₃, InI, TlI, SnI₂, GaI₃, and ZnI₂, although it may also comprise other gas filling components known in the art. The gas filling contained in the discharge vessel 3(2) may comprise, for example, one or more of NaI, TlI, CaI₂ and REIₙ (rare earth iodide) as components, or may comprise alternative gas filling components such as LiI, etc. REIₙ refers to rare earth compounds such as one or more of CeI₃, PrI₃, NdI₃, SmI₂, EuI₂, GdI₃, TbI₃, DyI₃, HoI₃, ErI₃, TmI₃, YbI₂, and LuI₃, but in an embodiment also includes one or more of Y (yttrium) iodides, Sc iodides, and La iodides. According to a specific embodiment of the invention, the rare earth iodide comprises dysprosium iodide. Such lamps are capable of providing especially good characteristics. In yet another specific embodiment, the rare earth iodide comprises cerium iodide. A second light source 202 comprising a discharge vessel 3(2) containing cerium iodide may further contain one or more iodides selected from for instance the group consisting of thallium, lithium, tin, calcium, indium, and sodium iodides in discharge vessel 3(2). Preferred fillings comprise Dy, Ce, Ho, or Tm as rare earth components. Further preferred fillings are based on Dy—Tl, Ce—Na, Ho—Tl, or Tm—Na. Yet other preferred fillings are based on Dy—Tl—Sn, Ce—Tl—Na, Ho—Tl—Na, Ho—Tl—Sn, or Tm—Tl—Sn. Other preferred fillings are based on Na—Tl—Ce—Ca, Na—Tl—Er, or Na—Tl—Pr. Filings based on Dy as the rare earth component are especially preferred. Any of these preferred gas filling components or gas fillings for the second light source 202 may also be used as preferred first light source 201, provided they satisfy the conditions for the first light source 201 as described above.

### Embodiments Wherein the Filling of the Second Light Source 202 Also Satisfies Equation (1)

Nevertheless, in a specific embodiment, the second ionizable gas filling in the second discharge vessel 3(2) also comprises one or more components selected from the group consisting of LiI, NaI, KI, RbI, CsI, MgI₂, CaI₂, SrI₂, BaI₂, ScI₃, YI₃, LaI₃, CeI₃, PrI₃, NdI₃, SmI₂, EuI₂, GdI₃, TbI₃, DyI₃, HoI₃, ErI₃, TmI₃, YbI₂, LuI₃, InI, TlI, SnI₂, GaI₃, and ZnI₂, the concentration h of the respective components in second discharge vessel (3(2)) in μg/cm³, satisfying the equation log h=A/T_{cs}²+B/T_{cs}+C+log z (equation (1)), wherein T_{cs} is the coldest-spot temperature of the discharge vessel 3(2) in Kelvin during nominal operation of the second light source 202, and wherein A, B, C, z, and T_{cs} are as defined above.

The above-mentioned parameters (Table 1; A, B, C, z, T_{cs}) and (maximum) values (Table 2) for the first discharge vessel 3(1) of the first light source 201 may therefore also be preferred parameters and preferred (maximum) values for the second discharge vessel 3(2) of the second light source 202 of the lighting device 200.

The embodiments described below refer to the embodiment of the second light source 202 also satisfying equation 1, but may also refer to embodiments of the first light source 201 per se (thus even in embodiments wherein the second light source 202 does not satisfy equation (1)). The gas filling components of the two discharge vessels 3(1), 3(2) are independent of each other, except for the fact that the color temperatures of the radiations 331, 332 generated by the first and second light sources 201, 202 are different.

Assuming, for example, a preferred embodiment with a coldest-spot temperature in the discharge vessel 3(2) (and/or (3(1)) of 1300 K or higher (at nominal operation), with, for example, only DyI₃ as the RE gas (in addition to mercury gas and a noble gas) in one of the discharge vessels, a preferred maximum concentration in said discharge vessels is about 378 μg/cm³ (z=1). In another example, assuming a preferred embodiment comprising a combination of Dy and Tl, Dy is preferably present in discharge vessel 3(2) (or (3(1)) in the form of DyI₃ at a concentration of ≦378 μg/cm³ and Tl is present in the form of TlI at a concentration of ≦9110 μg/cm³. If the second light source 202 (or first light source 201) is arranged to have a coldest-spot temperature higher than 1300 K (at nominal operation), these values for h may be higher, as can be derived from Table 2. In yet another example, a preferred embodiment relates to a lighting device 200 with the second light source 202 (or first light source 201) based on Dy, Tl, and Sn. In such an embodiment the second light source 202 (or first light source 201) is arranged to have a coldest-spot temperature in discharge vessel 3(2) (or (3(1)) of at least 1300 K and the preferred concentrations of DyI₃, TlI, and SnI₂ are ≦378 μg/cm³, 9110 μg/cm³, and 2.17*10⁴ μg/cm³, respectively.

In a preferred embodiment, the ionizable gas filling of the metal halide second light source 202 (and/or first light source 201) in the lighting device 200 according to the invention comprises one or more rare earth iodides selected from the group consisting of dysprosium iodide and holmium iodide, and the second (and/or first) ionizable gas filling comprises 10-370 μg/cm³, more preferably 10-300 μg/cm³, even more preferably 10-250 μg/cm³ of the one or more rare earth iodides selected, as applicable. In an embodiment in which the second (and/or first) ionizable gas filling comprises one or more rare earth iodides selected from the group consisting of cerium iodide and thulium iodide, the second (and/or first) ionizable gas filling preferably comprises ≦65 μg/cm³, more preferably ≦60 μg/cm³, even more preferably ≦50 μg/cm³ of the one or more rare earth iodides. Preferred maximum values for light sources which are arranged to have a T_{cs} at nominal operation of at least 1300 K, are the (maximum) values indicated in column of 1300 K in Table 2 above.

In an embodiment, the concentrations h of the respective components in the first and/or second discharge vessels 3(1), 3(2) satisfy the above equation (1) wherein z is 2 or less, more preferably 1.5 or less, even more preferably 1 or less, yet even more preferably 0.5 or less, such as 0.001-0.5, even more preferably 0.1 or less, such as 0.001-0.1. If z is greater than about lfor a component of the gas filling, the component will start to form condensation in the discharge vessel at the coldest spot having the coldest-spot temperature. In an embodiment of the invention, the lighting device 200 comprises one or more light sources 201, 202 whose fillings may comprise independently one or more elements selected from the group comprising Mg, Sc, Er, In, Tl, Sn, Zn, Y, Dy, Ho, Lu, Li, Ce, and Tm, the concentration h of the respective components satisfying equation (1), while z is 0.5 or less for Mg, Sc, Er, In, Tl, Sn, and Zn, z is 1.5 or less for Y, Dy, Ho, Lu, and Li, and z is 2 or less for Ce and Tm. For Ga, z is preferably 0.5 or less, such as 0.1 or less, or even 0.01 or less.

### Lighting Device

After the discussion of the first and second light sources 201 and 202, the lighting device 200 will now be described in more detail with reference to FIGS. 4a-b and 5.

FIGS. 4a and 4b schematically depict embodiments of the lighting device 200 according to the invention. The lighting device 200 comprises a first light source 201 comprising a first ceramic discharge vessel 3(1) with two electrodes 4(1), 5(1), the first discharge vessel 3(1) enclosing a first discharge volume 11(1) containing a first ionizable gas filling, as described above. The lighting device 200 further comprises a second light source 202 comprising a second ceramic discharge vessel 3(2) with two electrodes 4(2), 5(2), the second discharge vessel 3(2) enclosing a second discharge volume 11(2) containing a second ionizable gas filling, as described above. The first light source 201 is arranged to generate a first radiation 331 having a first color temperature and the second light source 202 is arranged to generate a second radiation 332 having a second color temperature, thereby generating light 335 with a third color temperature.

The term radiation (light) especially refers to visible radiation (VIS), i.e. radiation in the range of about 400 to 800 nm. The radiation generated by the light sources comprises white radiation (i.e. white light) in an embodiment. Light 335 represents the sum of two radiations 331 and 332. An embodiment also includes the situation wherein one of the light sources is switched off; the ranges over which the color point/color temperature of the lighting device 200 is variable is as broad as possible in this way. When one of the light sources is switched off, the third color temperature of light 335 is essentially the first or the second color temperature of the radiation 331 or 332 generated by light source 201 or 202, as applicable.

Lighting device 200 further comprises ballasts 410, 420 for operating the light sources 201 and 202, i.e. the first ballast 410 is arranged to operate the first light source 201 and the second ballast 420 is arranged to operate the second light source 202. The ballasts may be arranged outside the lighting device 200 or may be integrated in the lighting device 200. Ballasts are known in the art and are not described in detail. The ballasts 410, 420 are used to provide the desired power to the respective light sources 201 and 202 and are also used to dim the light sources 201, 202. They are sometimes also indicated as lamp driver circuits. They provide a high initial voltage to initiate the discharge in the HID lamp and then rapidly limit the lamp current to sustain the discharge safely. Ballasts 410 and 420 may also be integrated into one lamp-driver circuit, a so-called 2-lamp driver circuit. Such integrated ballasts for 2 (or more lamps) are known in the art.

Lighting device 200 further comprises a controller 500 (see also below) for controlling one or more parameters selected from the group consisting of the intensity of the first radiation 331 and the intensity of the second radiation 332, thereby controlling the third color temperature, i.e. the color temperature of the light 35 emitted by lighting device 200 and the intensity of the light 335 generated by the device 200. Preferably, controller 500 controls both the intensity of the first radiation 331 and the intensity of the second radiation 332.

In an embodiment, the light sources 201, 202 emit white light with a color temperature selected from the range of 2700 to 17000 K. In an embodiment, light sources 201, 202 are selected to provide a lighting device 200 which is able to provide light 335 with a color temperature (third color temperature) variable in a range of at least 1000 K. This means that, by tuning of the intensities of light sources 201, 202, light 335 is generated of which the color temperatures is at least 1000 K tunable, or in other words, the color temperature of the light 335 generated by lighting device 200 is tunable over 1000 K. In another embodiment, the range that can be covered is at least about 2000 K, more preferably at least 4000 K, more especially at least about 5000 K. In order to provide a lighting device 200 in which the third color temperature of light 335 is tunable (variable) in a range of about 1000 K, the difference in color temperatures of the two light sources 201 and 202 is preferably greater than about 1000 K, for example about 1400 K or more (at nominal operation of the respective light sources 201 and 202). Thus the third color temperature can be varied without the need of switching off one of the light sources 201, 202. This implies that the light sources 201,202 have different color temperatures (at least when operated at maximum power), differing by at least about 1400 K or more. For example, assuming first and second light sources 201, 202 having first and second color temperatures at maximum power of the sources of about 4200 K and 2800 K, respectively, the third color temperature of light 335 of lighting device 200 may be varied between about 4000 K and 3000 K, i.e. in a range of about 1000 K. If a wider tuning range is required, the difference in color temperatures of the light sources 201,202 is preferably even greater. The difference in color temperatures of the two light sources 201 and 202 at nominal operation is preferably at least 130%, more preferably at least 150%, even more preferably at least 190% of the desired range over which the third color temperature of the light 335 of the lighting 200 is variable (without substantially deviating from the BBL (i.e. preferably within 10 SDCM of the BBL)). For example, if the third color temperature is to be varied between about 3500 K and about 5300 K, the difference between the first and second color temperatures of the two light sources 201 and 202, may be about 4000 K (for example a first light source 201 having a first color temperature of about 7000 K at nominal operation and a second light source 202 having a second color temperature of about 3000 K at nominal operation. Here, the difference in color temperature of the light sources is about 220% of the desired tuning range); see also example 4. Hence, the difference in color temperatures of the first and the second light sources 201, 202 at nominal operation of the sources is preferably between about 130% and 300% of the desired tuning range. Tuning or varying the third color temperature may be done continuously or stepwise.

If the first light source 201 is arranged to generate light 331 with a relatively high first color temperature, the second light source 201 is preferably arranged to generate light 332 with a relatively low second color temperature (and vice versa). In an embodiment, the first light 201 source preferably has a relatively high color temperature, i.e. at least 5000 K, even more preferably at least about 6000 K (at nominal operation). Preferably, the second light source 202 has a relatively low color temperature, i.e. not more than about 4000 K, more preferably below about 3500 K (at nominal power operation). Hence, in a specific embodiment of the lighting device 200, the first light source 201 is arranged to generate radiation 331 with a first color temperature of at least about 6000 K and the second light source 201 is arranged to generate radiation 332 with a second color temperature of not more than about 4000 K. The greater the difference between the color temperatures of the first and the second light sources 201,202, the wider the range over which the color temperature of the lighting device can be varied.

Since InI-based light sources have a relatively high color temperature, such a lamp is preferably used as one of the light sources. When an InI-based lamp is chosen as the first light source 201, particularly good results are obtained with respect to stability of the color point of the first light source 201 and with respect to tunability over the entire color temperature range of light 335, without substantially deviating from the BBL. Therefore, in a preferred embodiment, the first ionizable gas filling comprises indium iodide (i.e. first light source 201 is InI-based).

Assuming, for example, a lighting device 200 having light source 202 with a color temperature of 2700 K and light source 201 with a color temperature of 7000 K (cool daylight), such as an InI-based lamp, the color temperature of light 335 of the lighting device 200 (i.e. the third color temperature) can be tuned by varying the intensities of the two sources (i.e. varying the intensities of radiations 331 and 332). In such an embodiment, the color temperature of the light 335 of the lighting device 200 is tunable over a range of about 4300 K (or less). In a preferred embodiment, therefore, the third color temperature of the lighting device 200 is at least variable in the range of about 2700-7000 K.

In a specific embodiment, a lighting device 200 is provided wherein the first and second color temperatures of the first and the second radiations 331, 332 have distances to the black body locus of equal to or less than 10 SDCM, preferably 5 SDCM or less, when the first and second light sources (201, 202) are operated at maximum power. This means that the first light source 201 is arranged to generate radiation 331 with a color point that differs from the point at the BBL closest to the color point of the radiation of the first light source 201 by 10 SCDM or less. The color point (x_{BBL1},y_{BBL1}) at the BBL closest to the color point (x_{cp1},y_{cp1}) of the radiation of first light source 201 is the color point (x_{BBL1},y_{BBL1}) that is found at the BBL when a perpendicular is drawn from the color point (x_{cp1},y_{cp1}) of the first light source to the BBL. The color point (x_{BBL1},y_{BBL1}) found at the intersection of the perpendicular and the BBL is the color point at the BBL closest to the first color point (x_{cp1},y_{cp1}). Likewise, this applies for the color point (x_{cp2},y_{cp2}) of the second radiation 332 and a closest color point (x_{BBL2},y_{BBL2}) at the BBL relative to this color point of the second radiation 332. Values above about 10 SCDM provide first and second light sources 201, 202 with relatively less pure white colors; the closer to the BBL, the purer the white, and the better the color rendering.

Preferably, the distance to the black body locus of the first color temperature of the first light source 201 is 10 SDCM or less, preferably 5 SDCM or less, even when dimming the light source in a range of 100-70%, more preferably 100-50% of its intensity at nominal operation. The dimming behavior of a first light source 201 fulfilling this criterion is depicted in FIG. 6.

In yet a further embodiment, a lighting device 200 is provided wherein the third color temperature (also) has a distance to the black body locus of equal to or less than 10 SDCM. This means that during dimming of one or both of the light sources 201, 202, the intermediate color points of the light 335 generated by the lighting device 200 are found close to the BBL (≦10 SDCM), which implies that relatively pure white colors are generated, i.e. light with a color temperature which is close to (or on) the BBL. Examples of such systems are given below and are depicted in FIGS. 7 and 8.

As mentioned above, the lighting device 200 according to the invention further comprises a controller 500 for controlling one or more parameters selected from the group consisting of the intensity of the first radiation 331 and the intensity of the second radiation 332, thereby controlling the third color temperature, i.e. the color temperature of the light 335 emitted by lighting device 200. The intensity of the light 335 can be controlled, but so can the third color temperature, in that the intensity of one (or preferably both) of the intensities of the first radiation 331 and the second radiation 332 is controlled. The controller 500 of the lighting device 200 according to invention may therefore have the ability to control the intensity of light 335 and/or the third color temperature of the light 335. In this way, the intensity of light 335 may be varied at constant CCT and/or the third color temperature of the light 335 may be varied.

Hence, controller 500 (which may be externally arranged from lighting device 200) is used for tuning or varying the color temperatures of the respective light sources 201, 202. Controller 500 may be a “only hardware” system with, for example, switches such as touch controls, slide switches, etc. for controlling the intensities of light sources 201, 202 or to select the desired color temperature or color effect (such as “warm”, “cold”), depending on the application of lighting device 200, the user's mood, etc., (which selection is subsequently translated into color temperatures of light sources 201, 202 by the controller 500). Furthermore, the color temperature of lighting device 200 may be dependent on external parameters like time, temperature, light intensity of external sources (such as the sun), color temperature of external sources, etc., which may be measured by sensors (see also below). Controller 500 may be operated via a remote control. Controller 500 controls the intensities of light sources 201, 202 via respective ballasts 410, 420 (or one integrated ballast 410/420). A power supply provides the electric power to the controller and the ballasts 410, 420.

In yet another embodiment, controller 500 may comprise:

a memory 501, with executable instructions;

an input-output unit 502 configured to (i) receive one or more input signals from one or more selected from the group consisting of (1) one or more sensors and (2) a user input device, and (ii) send one or more output signals to control the color temperatures of light sources 201, 202; and

a processor 503 designed to process the one or more input signals into one or more output signals based on the executable instructions.

The executable instructions relate, for example, signals (input signal) generated by the above-mentioned switches, remote control and sensors (see also below) with the intensities of light sources 201, 202 obtained via ballasts 410, 420 (output signal), thus providing the color temperature of the light 335 of lighting device 200 desired by the user or desired for the specific application. Furthermore, the controller may be designed to vary the color temperature of lighting device 200 with time, for example periodically or randomly. In another embodiment, the controller may be designed to provide an increase in color temperature of the light 335 over time. For example, a lighting device 200 may be provided of which the color temperature is variable from warm white to cool daylight. Such an increase may be beneficial, for example, in helping people to wake up (“wake-up mode”).

Hence, controller 500 may provide one or more functions selected from the group consisting of switching on and off one or both of the first light source 201 and the second light source 202; determining the color temperature of light 335; determining the color type such as “warm-white” and “cool-daylight” of light 335, and modes in-between (or beyond); determining lighting patterns such as random or periodic changes in the color temperature or a gradual increase (“wake-up”) or decrease of the color temperature of light 335; and determining whether or not one or both of the color temperature and lighting pattern of light 335 is/are dependent on one or more external parameters such as time, temperature, light intensity of external sources, etc.

As mentioned above, the lighting device 200 according to the invention may further comprise one or more sensors, which are referenced 701 and in a preferred embodiment are arranged to measure the third color temperature of the light 335 generated by the device 200 and to generate a signal having a relation with the measured third color temperature (input signal), wherein the controller 500 is arranged to generate a control signal (output signal) for controlling the third color temperature of the light 335 in dependence on a predetermined value and the signal generated by the one or more sensors 701. A feedback control loop can thus be provided that regulates the lamp ballast(s) 410, 420 to provide the desired third color temperature. The predetermined value may be set, for example, by a user via the user input device, which may comprise, for example, a switch such as a touch control, a slide switched, etc., as known to those skilled in the art. The lighting device 200 may comprise one sensor 701 or may alternatively comprise a sensor arrangement comprising more sensors 701. Sensors 701 are schematically depicted in FIGS. 4a, 4b and 5.

A specific embodiment of the lighting device 200 according to the invention is depicted in FIG. 4a. Each light source 201 and 202 has its own “bulb”, “shell” or envelope 100(1) and 100(2). Optionally, both light sources 201 and 202 may further be enclosed by a larger envelope 1000. In another embodiment schematically depicted in FIG. 4b, however, both discharge vessels 3(1) and 3(2) of the first and second light sources 201, 202, respectively, are encompassed by one envelope 1000, which takes the place of envelopes 100(1) and 100(2). The volume enclosed by envelopes 100(1), 100(2), and 1000(3), as applicable, contains vacuum or nitrogen. Examples of such configurations are disclosed in JP10312897 and KR20020093743.

FIG. 5 schematically discloses a further embodiment, wherein first and second light sources 201, 202 are at least partially surrounded by a reflector 600. Reflector 600 is arranged to mix the radiations 331,332 of the two light sources 201, 202 and provide a well mixed light 335. Hence, in a specific embodiment, the first and second light sources 201, 202 of the lighting device 200 according to the invention are at least partially surrounded by the reflector 600, which is arranged to mix the first radiation 331 and the second radiation 332 so as to provide substantially homogeneous light 335. FIG. 5 schematically depicts two light sources 201 and 202 with individual envelopes 100(1) and 100(2) enclosing the discharge vessels 3(1) and 3(2), respectively. However, the reflector configuration depicted in FIG. 5 may also be used in combination with an envelope 1000 that encloses both discharge vessels 3(1) and 3(2). Other configurations than those depicted in FIG. 5 are also possible, for example as described in US20050225986 and WO2003048634. In a specific embodiment (not shown), one or more sensors 701 may be arranged behind the reflector 600 (the light sources 100(1) and 100(2) lie substantially within the reflector 600), receiving light 335 through a small hole (a “light leak”) in the reflector. One or more sensors may also be integrated in the reflector 600.

As will be clear to those skilled in the art, the terms first and second light sources 201 and 202, respectively, are interchangeable, under the conditions (1) that at least one of the light sources satisfy the equation given above (i.e. z is between 0.001 and 2, A, B, and C are as indicated in Table 1, and the coldest-spot temperature T™ at maximum power operation is at least 1100 K), and (2) that the light sources 201 and 202 are arranged to generate respective radiations 331 and 332 such that the difference in color temperature between them is at least 1400 K. It will also be clear to those skilled in the art that the first light source 201 may also have a lower color temperature than the second light source 202, as long as the difference in color temperature is at least about 1400 K at nominal operation of the light sources 201, 202 (see also above). The lighting device 200 according to the invention has two light sources 201 and 202. The advantages described herein are obtained by using the first and second light sources 201 and 202 described herein. However, the lighting device 200 may also comprise more than two light sources.

Hence, the invention provides a lighting device 200 which is color-variable without a substantial deviation form the black body locus of the light generated by the lighting device 200. The lighting device 200 can also be dimmed without a substantial shift of the color point of the light generated by the lighting device 200. The lighting device is based on at least two CDM lamps 201, 202.

As will be clear to those skilled in the art, the essential components of the first and second gas fillings, i.e. the one or more components which essentially influence the color temperatures of the light 331 and the light 332, will in general be different. For example, Dy- or Er-based light sources have a relatively low color temperature, whereas In- or Ga-based light sources have a relatively high temperature.

### EXAMPLES

### Example 1

### Example of Lamp/Discharge Vessel According to the Invention

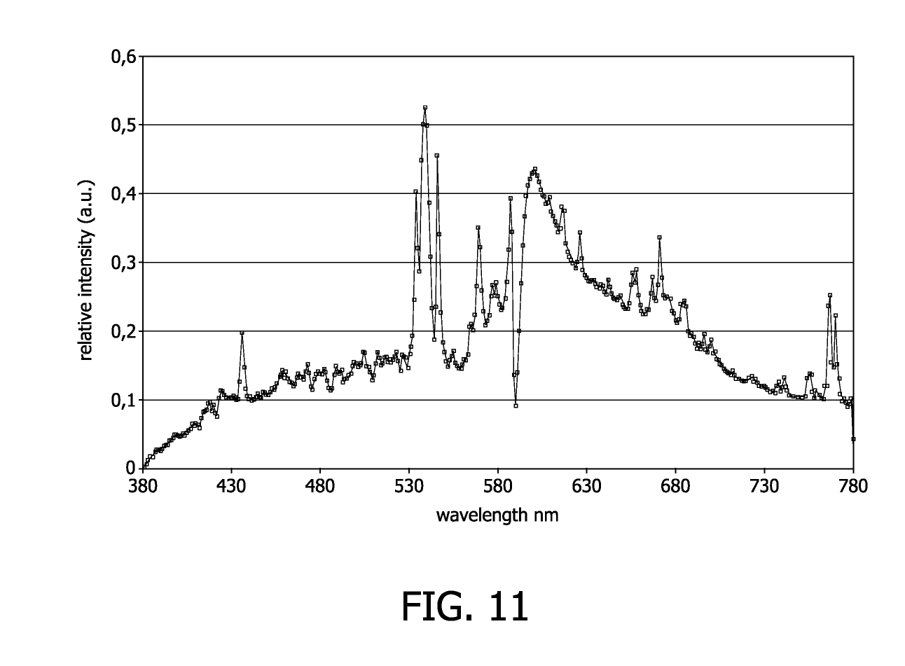

A light source 201 with a discharge vessel 3(1) having a volume of 0.32 cm³ was made. The discharge vessel 3(1) contained the following filling: 600 μg InI, 4 mg Hg, and 300 mbar Ar. The InI concentration was 1875 μg/cm³. The light source 201 was operated at 220 V, 50 Hz, in a room temperature environment. The coldest-spot temperature was 1300 K (±50 K) at nominal power (100 W) and 1200 K at 70 W. The color point, color rendering (Ra), and luminous efficacy as a function of the power are shown in FIGS. 9 and 11. The estimated wall load was about 40 W/cm². The InI concentration in this light source 201 was chosen such that InI was in the gas phase over the entire range of 70-100 W (resulting in a temperature range of 1200 K-1300 K). FIG. 8b shows the spectrum of the light source 201 at 70 W. Ra=90; R9 is 55; the efficacy is 62.3 μm/W, T_{c} (color temperature)=7040 K and the CIE coordinates (x,y) are 0.3050, 0.3201.

### Example 2

### Dimming Behavior of the Lamp of Example 1

The dimmability (extent to which a lamp can be dimmed from intensity at nominal operation (i.e. maximum power) down to lower intensities) was measured for the light source 201 of example 1. It was found that the lamp can be dimmed within a range of 100-70 W without leaving a 5 SDCM range (which is a range that is acceptable for many applications): the CCT stays constant for this single light source 201, see also FIGS. 6 and 9. This means that dimming percentages of about at least 30% of the intensity at nominal operation (i.e. dimming to 70% of the intensity at nominal operation) can at least be achieved.

It was further found also in this case that the dependence of the photometric properties on the orientation of the light source 201 (horizontal or vertical) is substantially less in the light source 201 than in comparable prior art lamps.

### Example 3

### Dimming Behavior of Light Source 201 of Example 1 Compared with Other Lamps

Table 3 gives an overview of the lamps tested:

TABLE 3
lamps of which the dimming behavior was tested (see also FIG. 6)

| | | | Power range |
|---|---|---|---|
| Lamp type | CCT (K) | Ra | measured |
| CDM 70 W 828 * + | 2800 | 76 | 20-70 W |
| CDM 70 W 830 * + | 3000 | 80 | 20-70 W |
| CDM 70 W 930 * + # | 3000 | 90 | 20-70 W |
| CDM 70 W 942 * + | 4000 | 90 | 20-70 W |
| Osram PB shoplight 70 W 930 * + | 3000 | 90 | 20-70 W |
| CDM unsat InI 70 W + ## | 7000 | 90 | 20-70 W |

* prior art lamps
+ depicted in FIG. 6
#, ## used as lamps 202 and 201, respectively, in Example 4

The dimming possibilities of the lamps indicated with “+” are shown in FIG. 6. It appears that the light source 201 of the lighting device 200 according to the invention shows the best behavior in that the green shift is negligible. Advantageously, furthermore, the shift found lies within about 5 SDCM from the BBL, even down to about 35% of the maximum power of first light source 201.

### Example 4

### Example of Color Variation by Mixing Two CDM Burners

A color-variable HID lighting device can be constructed on the basis of the measured data from the lamps of Table 3 above in that a high CCT and a low CCT burner are chosen and their light outputs are mixed at different power levels.

An example will now be given of such a lighting device 200. For the high CCT lamp, a first light source 201 is selected as described in examples 1 and 2 and denoted “CDM unsat InI 70 W”. The second light source 202, a CDM 70 W 930 lamp, is selected as the low CCT lamp here. Then, a wide range of color variability is obtained with light 335 with a limited shift from the BBL, see also FIG. 6. The LTP (photometric properties) data for the color variation were measured in that the combined lamps were operated together in a measuring sphere and the obtainable CCT range was tuned. The results are shown in Table 4 and FIG. 7a:

TABLE 4
Photometric properties of a device with an InI-based first light
source and a commercially available CDM as second light source.

| | CDM Unsat | | | | | | | |
|---|---|---|---|---|---|---|---|---|
| CDM 70 W 930 | InI | CCT | | | | | | |
| Pla* (W) | Pla (W) | K | x | y | Ra | R9 | lumens | Lm/W |
| 30 | 70 | 5301 | 0.338 | 0.358 | 87 | −22 | 6488 | 65 |
| 35 | 65 | 4894 | 0.349 | 0.358 | 87 | −24 | 6758 | 68 |
| 40 | 60 | 4461 | 0.362 | 0.361 | 88 | −18 | 7244 | 72 |
| 45 | 55 | 4142 | 0.372 | 0.364 | 88 | −16 | 7368 | 74 |
| 50 | 50 | 3902 | 0.381 | 0.365 | 89 | −4 | 7665 | 77 |
| 55 | 45 | 3713 | 0.388 | 0.368 | 90 | 7 | 7877 | 79 |
| 60 | 40 | 3588 | 0.394 | 0.370 | 92 | 22 | 8027 | 80 |
| 65 | 35 | 3482 | 0.399 | 0.372 | 93 | 39 | 8198 | 82 |
| 70 | 30 | 3406 | 0.403 | 0.375 | 93 | 47 | 8220 | 82 |

Individual burners at 70 W nominal power:

| | | | | | | | | |
|---|---|---|---|---|---|---|---|---|
| 0 | 70 | 7041 | 0.305 | 0.320 | 90 | 55 | 4777 | 68 |
| 70 | 0 | 3022 | 0.433 | 0.399 | 90 | 29 | 7157 | 102 |

*Pla: power of the individual lamp

The results show a CCT range of more than 2000K close to the BBL (≦10 SDCM) with a high color rendering index (88<Ra<94 over the full range), because both individual burners have Ra>90 at 70 W nominal power.

### Example 5

### Example of Dimming at Constant CCT by Mixing Two CDM Burners

A well-known problem with dimming of metal halide lamps is the color shift to the green as a result of the reduced vapor pressures inside the arc tube. As shown in FIG. 6, all prior art CDM lamps suffer from this drawback, some types more than others. This problem limits the practical lower limit for dimming to about 60-70% power if color quality is required to stay up.

During the experiments with color mixing with CDM 70 W 930 and the first light source 201 as described above, it was also surprisingly discovered that the color point was hardly influenced if the two burners were dimmed simultaneously. The effect, illustrated in FIG. 7b, is caused by the specific trajectories of the color points of the individual burners: in this embodiment the CDM 70 W 930 burner shifts to above the BBL whereas the unsat InI burner shifts to below the BBL. It appears that a system can be provided that can be dimmed down to 30% power at nearly constant color point around 4000 K. For reference, the dimming curves down to 30% are also given for individual burners in FIG. 7b, demonstrating the drastic improvement provided by the 2-burner system.

This result was experimentally verified by measuring LTP data of the combined system over a power range from 135 to 75 W, see Table 5.

TABLE 5
Photometric properties of a device with an InI-based first light source
and a CDM 70 W 930 lamp as a second light source at constant CCT:

| | CDM 70 W 930 + | | | | | | lumen | luminous |
|---|---|---|---|---|---|---|---|---|
| | CDM Unsat InI | CCT | | | | | output | efficacy |
| Pla total (W) | Pla1 + Pla2 (W) | K | x | y | Ra | R9 | lm | lm/W |
| 75 | 38 + 37 | 4090 | 0.3758 | 0.3711 | 82 | −53 | 4489 | 60 |
| 80 | 40 + 40 | 4033 | 0.3775. | 0.3702 | 84 | −42 | 4999 | 62 |
| 92 | 42 + 50 | 4132 | 0.3733 | 0.3671 | 87 | −27 | 5808 | 63 |
| 107 | 47 + 60 | 4078 | 0.3750 | 0.3665 | 89 | −9 | 6855 | 64 |
| 121 | 51 + 70 | 4105 | 0.3738 | 0.3654 | 91 | 5 | 7793 | 64 |
| 136 | 56 + 80 | 4099 | 0.3739 | 0.3650 | 93 | 23 | 8859 | 65 |

Hence, when dimming at constant CCT, a variation even within the 5 SDCM range is possible for the lighting device 200 according to the invention.

### Example 6

### Example of Lamp/Discharge Vessel According to the Invention

This example relates to a light source or lamp that can be used as a first or second light source 201, 202, respectively. Due to its properties, it at least fulfils the criteria described herein for a first light source 201. Whereas the InI-based first light source 201 described above in examples 1 and 2 has a relatively high color temperature, the light source described below has a relatively low color temperature. Hence, the lamp described in these examples 6 and 7 may be used, for example, in a lighting device 200 as the second light source 202 in combination with a first light source 201 as described above, which would provide a lighting device 200 wherein both the first and the second light source 201, 202, fulfill the conditions of claim 1e, but the lamp as described in these examples 6 and 7 may also be used as a first light source 201 in combination with a second light source 202 with a high color temperature, for example an InI lamp wherein z is 5 or higher.

A lamp with a discharge vessel 3 having a volume of 1.8 cm³ was made. The discharge vessel 3 contained the following filling: 140 μg NaI, 980 μg TlI, 120 μg DyI₃, 30 mg Hg, and 300 mbar Ar. Hence, the concentration of DyI₃=67 μg/cm³<1560 μg/cm³ (1400 K), the concentration of TlI=544 μg/cm³<17,000 μg/cm³ (1400 K), and the concentration of NaI=78 μg/cm³<148 μg/cm³ (1400 K). The lamp was operated at 220 V, 50 Hz, in a room temperature environment. An emission spectrum of this lamp is shown in FIG. 11.

The coldest-spot temperature was 1400 K (±50 K) at nominal power (300 W) and about 1150 K at 160 W. The color point, color rendering (Ra), and efficacy are shown in FIG. 11 as a function of the power. The estimated wall load was about 75 W/cm². Hence, the concentration of the gas filling components fulfills the criteria as given above in the Table for a coldest-spot temperature of 1400 K at a nominal operating power of 300 W. The gas filling components remain unsaturated over at least part of the range of 300-150 W. At about 1150 K, however, the concentrations of NaI and DyI₃ are slightly above the values as derived from the equation and indicated in Table 2, assuming z=1. Given the amount of mercury as indicated herein, all mercury is also in the gas phase during operation, even at 160 W.

FIG. 11 shows the spectrum of the lamp at 250 W. Ra=96.4; R9 is 67.5; the efficacy is 83.2 μm/W, T_{c} (color temperature)=3336 K, and the CIE coordinates (x,y) are 0.4134, 0.3917.

### Example 7

### Dimming Behavior of the Lamp of Example 6

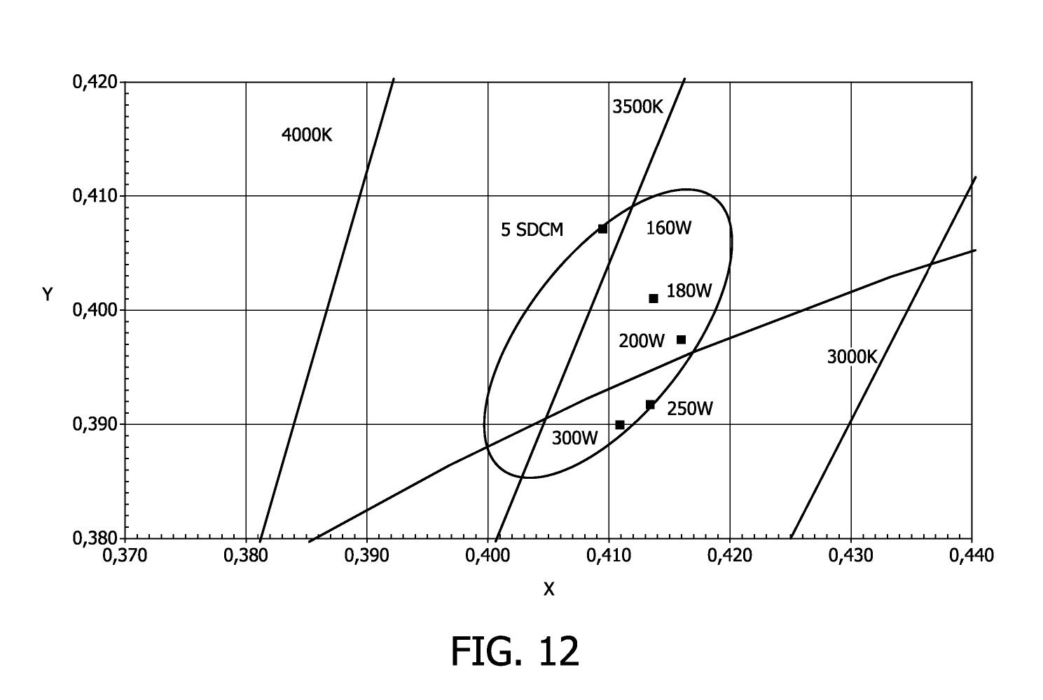

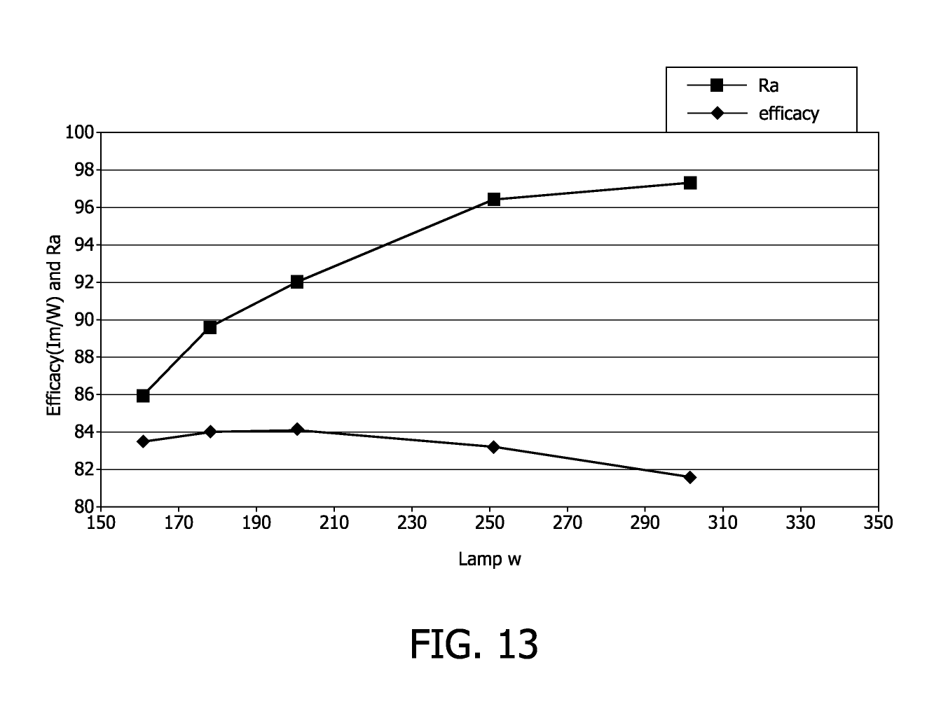

The dimmability (extent to which a lamp can be dimmed from intensity at nominal operation (i.e. maximum power) down to lower intensities) was measured for the lamp of example 6 (see FIG. 11). It appears that the lamp can be dimmed within a range of 300-160 W without leaving a 5 SDCM range (which is a range that is acceptable for many applications). This means that dimming percentages of about at least 50% of the intensity at nominal operation can be achieved. The variation of the color point as a function of the power is given in FIG. 12; the luminous efficacy and Ra as a function of the power is shown in FIG. 13.

It is further found that the photometric properties of the lamp are substantially less dependent on the orientation of the lamp according to the invention (horizontal or vertical) than in comparable prior art lamps.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware.

The mere fact that certain measures are recited in mutually different dependent claims does not indicate that a combination of these measures cannot be used to advantage.

1. A lighting device (200) arranged to generate light (335), comprising:
a) a first light source (201) comprising a first ceramic discharge vessel (3(1)) with two electrodes (4(1),5(1)), the first discharge vessel (3(1)) enclosing a first discharge volume (11(1)) containing a first ionizable gas filling;
b) a second light source (202) comprising a second ceramic discharge vessel (3(2)) with two electrodes (4(2),5(2)), the second discharge vessel (3(2)) enclosing a second discharge volume (11(2)) containing a second ionizable gas filling;
c) the first light source (201) being arranged to generate a first radiation (331) having a first color temperature and the second light source (202) being arranged to generate a second radiation (332) having a second color temperature, the lighting device (200) thereby generating light (335) with a third color temperature;
d) a controller (500) for controlling one or more parameters selected from the group comprising the intensity of the first radiation (331) and the intensity of the second radiation (332);
e) wherein the first ionizable gas filling comprises one or more components selected from the group comprising LiI, NaI, KI, RbI, CsI, MgI₂, CaI₂, SrI₂, BaI₂, ScI₃, YI₃, LaI₃, CeI₃, PrI₃, NdI₃, SmI₂, EuI₂, GdI₃, TbI₃, DyI₃, HoI₃, ErI₃, TmI₃, YbI₂, LuI₃, InI, TlI, SnI₂, GaI₃, and ZnI₂, wherein the concentration h of the respective components in first discharge vessel (3(1)) in μg/cm³, satisfy the equation:
log h=A/T_{cs}²+B/T_{cs}+C+log z,
wherein T_{cs} is the coldest-spot temperature of discharge vessel (3(1)) in Kelvin during nominal operation of the first light source (201), wherein A, B and C are defined as follows:

| Component | A*10⁻⁶ | B*10⁻³ | C |
|---|---|---|---|
| LiI | −0.51 | −5.88 | 7.16 |
| NaI | −1.30 | −5.82 | 6.99 |
| KI | −2.51 | −3.48 | 5.66 |
| RbI | −2.04 | −4.95 | 6.48 |
| CsI | −1.40 | −5.72 | 7.13 |
| MgI₂ | −1.92 | −4.40 | 8.20 |
| CaI₂ | −3.45 | −5.99 | 6.83 |
| SrI₂ | −1.99 | −9.33 | 8.05 |
| BaI₂ | −2.15 | −10.00 | 8.47 |
| ScI3 | −17.70 | 18.76 | 0.16 |
| YI₃ | −7.96 | 0.43 | 6.41 |
| LaI₃ | −4.24 | −4.66 | 6.98 |
| CeI₃ | −3.15 | −7.37 | 9.36 |
| PrI₃ | −1.98 | −7.86 | 8.43 |
| NdI₃ | −4.29 | −4.42 | 6.58 |
| SmI₂ | −1.62 | −11.20 | 9.71 |
| EuI₂ | −1.95 | −10.50 | 8.95 |
| GdI₃ | −9.69 | 4.26 | 3.62 |
| TbI₃ | −9.41 | 4.09 | 3.59 |
| DyI₃ | −11.90 | 6.42 | 4.68 |
| HoI₃ | −9.48 | 3.15 | 5.61 |
| ErI₃ | −12.10 | 6.54 | 5.46 |
| TmI₃ | −3.12 | −5.25 | 7.64 |
| YbI₂ | −1.33 | −10.10 | 8.45 |
| LuI₃ | −9.00 | 3.37 | 5.38 |
| InI | −1.30 | −2.02 | 6.11 |
| TlI | −1.36 | −2.92 | 7.01 |
| SnI₂ | −1.99 | −1.14 | 6.39 |
| GaI₃ | −2.23 | 1.49 | 6.32 |
| ZnI₂ | −2.58 | 0.65 | 5.23 |

and wherein T_{cs} is at least 1100 K and z is between 0.001 and 2.

2. The lighting device (200) according to claim 1, wherein the first ionizable gas filling comprises indium iodide.

3. The lighting device (200) according to claim 1, wherein z is equal to or smaller than 1.

4. The lighting device (200) according to claim 1, wherein z is equal to or smaller than 0.5.

5. The lighting device (200) according to claim 1, wherein the first discharge vessel (3(1)) is arranged to have a coldest-spot temperature T_{cs} of at least 1200 K during nominal operation of the first light source (201).

6. The lighting device (200) according to claim 1, wherein the first discharge vessel (3(1)) is arranged to have a coldest-spot temperature T_{cs} in the range of 1350-1600 K during nominal operation of the first light source (201).

7. The lighting device (200) according to claim 1, comprising more than two light sources.

8. The lighting device (200) according to claim 1, wherein the difference between the first color temperature and the second color temperature is at least 1400 K.

9. The lighting device (200) according to claim 1, wherein the first light source (201) is arranged to generate radiation (331) with a first color temperature of at least 6000 K and wherein the second light source (201) is arranged to generate radiation (332) with a second color temperature of not more than 4000 K.

10. The lighting device (200) according to claim 1, wherein the third color temperature is at least variable over a range of 2700-7000 K.

11. The lighting device (200) according to claim 1, wherein the first and second color temperatures of the first and second radiations (331, 332) have distances to the black body locus (BBL) of less than 5 SDCM during nominal operation of the respective first and second light sources (201, 202).

12. The lighting device (200) according to claim 1, wherein the third color temperature has a distance to the black body locus (BBL) of less than 5 SDCM.

13. The lighting device (200) according to claim 1, wherein the second ionizable gas filling also comprises one or more components selected from the group consisting of LiI, NaI, KI, RbI, CsI, MgI₂, CaI₂, SrI₂, BaI₂, ScI₃, YI₃, LaI₃, CeI₃, PrI₃, NdI₃, SmI₂, EuI₂, GdI₃, TbI₃, DyI₃, HoI₃, ErI₃, TmI₃, YbI₂, LuI₃, InI, TlI, SnI₂, GaI₃, and ZnI₂, wherein the concentration h of the respective components in the second discharge vessel (3(2)) in μg/cm³ satisfies the equation log h=A/T_{cs}²+B/T_{cs}+C+log z, wherein T_{cs} is the coldest-spot temperature of the discharge vessel (3(2)) in K during nominal operation of the second light source (202), and wherein A, B, C, z, and T_{cs} are as defined in claim 1.

14. The lighting device (200) according to claim 13, wherein the second ionizable gas filling comprises DyI₃ and wherein the concentration h of the DyI₃ in the second discharge vessel (3(2)) satisfies the equation of claim 13.

15. The lighting device (200) according to claim 1, wherein the first discharge vessel (3(1)) and the second discharge vessel (3(2)) are enclosed in one envelope (1000).

16. The lighting device (200) according to claim 1, wherein the first and second light sources (201, 202) are at least partially surrounded by a reflector (600), and wherein the reflector (600) is arranged to mix the first radiation (331) and the second radiation (332).

17. The lighting device (200) according to claim 1, further comprising one or more sensors (701) arranged to measure the third color temperature of the light (335) generated by the device (200) and to generate a signal that represents the measured third color temperature, wherein the controller (500) is arranged to generate a control signal for controlling the third color temperature of the light (335) in dependence on a predetermined value and said signal generated by the one or more sensors (701).
